(19) United States
(12) Patent Application Publication
(10) Pub. No.: US 2025/0203598 A1
(43) Pub. Date: Jun. 19, 2025

(54) INCREASING RELIABILITY OF BLUETOOTH LOW ENERGY AUDIO LINKS

(71) Applicant: QUALCOMM Incorporated, San Diego, CA (US)

(72) Inventors: Giriraj GOYAL, Bangalore (IN); Vishal AGARWAL, Bangalore (IN); Nitin Raghavendra KIDIYOOR, Bangalore (IN); Skanda Kumar KAIPU NARAHARI, Bangalore (IN)

(21) Appl. No.: 18/836,270

(22) PCT Filed: Mar. 31, 2023
(86) PCT No.: PCT/US2023/017166

§ 371 Date: Aug. 6, 2024

(30) Foreign Application Priority Data
Apr. 15, 2022 (IN) 202241022438

(51) Int. Cl. H04W 72/12; H04B 17/309; H04B 17/318

(52) U.S. Cl. CPC H04W 72/12; H04B 17/328; H04B 17/346

(57) ABSTRACT

In some implementations, a wireless device schedules Bluetooth packets for transmission to a peripheral device over a Bluetooth link during an event, and obtains a number of sub-events (NSE) and a burst number (BN) for the event, the BN indicating the number of Bluetooth packets scheduled for transmission during the event, the NSE indicating the number of sub-events within the event. The wireless device obtains a minimum transmission attempt (minTx) value for the scheduled Bluetooth packets, the minTx value indicating a minimum number of transmission attempts allocated for each of the scheduled Bluetooth packets during the event. The wireless device determines flush points of the scheduled Bluetooth packets based at least in part on the minTx value, and transmits one or more of the scheduled Bluetooth packets over the Bluetooth link during the event based at least in part on the determined flush points.

### CROSS REFERENCES

The present Application is a 371 national stage filing of International PCT Application No. PCT/US2023/017166 by Goyal et al. entitled “INCREASING RELIABILITY OF BLUETOOTH LOW ENERGY AUDIO LINKS,” filed Mar. 31, 2023; and claims priority to Indian patent application Ser. No. 202241022438 by Goyal et al., entitled “INCREASING RELIABILITY OF BLUETOOTH LOW ENERGY AUDIO LINKS,” filed Apr. 15, 2022, each of which is assigned to the assignee hereof, and each of which is expressly incorporated by reference in its entirety herein.

### TECHNICAL FIELD

This disclosure relates generally to wireless communications, and more specifically, to transmitting Bluetooth data over Low Energy (LE) links.

### DESCRIPTION OF THE RELATED TECHNOLOGY

A wireless personal area network (WPAN) is a short-range wireless network typically established by a user to interconnect various personal devices, sensors, and/or appliances located within a certain distance or area of the user. For example, WPANs based on communication protocols such as a Bluetooth® (BT) protocol, a Bluetooth® Low Energy protocol, or a Zigbee® protocol may provide wireless connectivity to peripheral devices within a specific distance (such as 5 meters, 10 meter, 20 meters, 100 meters, etc.) of the user.

Bluetooth is a short-range wireless communication protocol that supports a WPAN between a central device (such as a host device) and at least one peripheral device (such as a client device). Power consumption associated with Bluetooth communications may render Bluetooth impractical in certain applications.

To address the power consumption issue associated with the Bluetooth protocol, Bluetooth® Low Energy (BLE) was developed and adopted in various applications in which data transfers occur relatively infrequently. Specifically, BLE exploits the infrequent transfer of data by using a low duty cycle operation, and placing one or both the central device and the peripheral device(s) into a sleep mode between data transmissions, thereby conserving power. Example applications that use BLE include battery-operated sensors and actuators in various medical, industrial, consumer, and fitness applications. BLE may also be used to connect devices such as BLE enabled smart phones, tablets, and laptops. While traditional Bluetooth and BLE offer certain advantages, there exists a need for further improvements in Bluetooth and BLE technology. For example, traditional Bluetooth and BLE communications have limited range, have limited data capacity throughput, and are susceptible to interference from other devices communicating in the same frequency band (such as Wi-Fi communications).

### SUMMARY

The systems, methods and devices of this disclosure each have several innovative aspects, no single one of which is solely responsible for the desirable attributes disclosed herein.

One innovative aspect of the subject matter described in this disclosure can be implemented as a method for wireless communication by a wireless device. In some implementations, the method includes scheduling Bluetooth packets for transmission to a peripheral device over a Bluetooth link during an event. The method includes obtaining a number of sub-events (NSE) and a burst number (BN) for the event, the BN indicating the number of Bluetooth packets scheduled for transmission during the event, the NSE indicating the number of sub-events within the event. The method includes obtaining a minimum transmission attempt (minTx) value for the scheduled Bluetooth packets, the minTx value indicating a minimum number of transmission attempts allocated for each of the scheduled Bluetooth packets during the event. The method includes determining flush points of the scheduled Bluetooth packets based at least in part on the minTx value, where the number of sub-events between the respective flush points of sequentially scheduled Bluetooth packets is based on the minTx value. The method includes transmitting one or more of the scheduled Bluetooth packets over the Bluetooth link during the event based at least in part on the determined flush points. In various implementations, the minTx value is obtained independently of at least one of the NSE or the BN. In some aspects, the Bluetooth link may be one of a Low Energy (LE) connected isochronous (ISO) link or an LE broadcast ISO link.

In some instances, the minTx value is equal to 0, and the scheduled Bluetooth packets share a common flush point. In some aspects, the common flush point occurs in a last sub-event of the NSE sub-events. In other instances, the minTx value is equal to 1, and the respective flush points of the scheduled Bluetooth packets occur in a set of contiguous sub-events of the NSE sub-events. In some aspects, the contiguous sub-events correspond to a last number of the NSE sub-events within the event, the last number being equal to BN. In some other instances, the minTx value is equal to 2, and the flush points of the scheduled Bluetooth packets occur in alternating sub-events of the NSE sub-events. In some aspects, the alternating sub-events correspond to a last number of the NSE sub-events within the event, the last number being equal to 2*BN.

In some implementations, the method may also include obtaining a packet error rate (PER) associated with the transmission of one or more of the scheduled Bluetooth packets over the Bluetooth link, and selectively adjusting the minTx value based at least in part on the obtained PER. In some instances, selectively adjusting the minTx value includes decreasing the minTx value responsive to the obtained PER being greater than a first PER threshold, or increasing the minTx value responsive to the obtained PER being less than a second PER threshold, the first PER threshold being greater than the second PER threshold.

In some other implementations, the method may also include obtaining an indication of a signal strength associated with the transmission of one or more of the scheduled Bluetooth packets over the Bluetooth link, and selectively adjusting the minTx value based at least in part on the indication. In various aspects, the indication includes one or more of a received signal strength indicator (RSSI), a signal-to-noise ratio (SNR), a signal-to-interference plus noise ratio (SINR), or an energy level of a respective Bluetooth packet transmitted over the Bluetooth link. In some instances, selectively adjusting the minTx value includes increasing the minTx value responsive to the indicated signal strength being greater than a first value, or decreasing the minTx value responsive to the indicated signal strength being less than a second value, the first value being greater than the second value.

Another innovative aspect of the subject matter described in this disclosure can be implemented in a wireless device. The wireless device may include one or more processors coupled to a memory. In some implementations, the memory stores processor-readable code that, when executed by the one or more processors, is configured to schedule Bluetooth packets for transmission to a peripheral device over a Bluetooth link during an event. Execution of the processor-readable code is configured to obtain a number of sub-events (NSE) and a burst number (BN) for the event, the BN indicating the number of Bluetooth packets scheduled for transmission during the event, the NSE indicating the number of sub-events within the event. Execution of the processor-readable code is configured to obtain a minTx value for the scheduled Bluetooth packets, the minTx value indicating a minimum number of transmission attempts allocated for each of the scheduled Bluetooth packets during the event. Execution of the processor-readable code is configured to determine flush points of the scheduled Bluetooth packets based at least in part on the minTx value, where the number of sub-events between the respective flush points of sequentially scheduled Bluetooth packets is based on the minTx value. Execution of the processor-readable code is configured to transmit one or more of the scheduled Bluetooth packets over the Bluetooth link during the event based at least in part on the determined flush points. In various implementations, the minTx value is obtained independently of at least one of the NSE or the BN. In some aspects, the Bluetooth link may be one of an LE connected ISO link or an LE broadcast ISO link.

In some instances, the minTx value is equal to 0, and the scheduled Bluetooth packets share a common flush point. In some aspects, the common flush point occurs in a last sub-event of the NSE sub-events. In other instances, the minTx value is equal to 1, and the respective flush points of the scheduled Bluetooth packets occur in a set of contiguous sub-events of the NSE sub-events. In some aspects, the contiguous sub-events correspond to a last number of the NSE sub-events within the event, the last number being equal to BN. In some other instances, the minTx value is equal to 2, and the flush points of the scheduled Bluetooth packets occur in alternating sub-events of the NSE sub-events. In some aspects, the alternating sub-events correspond to a last number of the NSE sub-events within the event, the last number being equal to 2*BN.

In some implementations, execution of the processor-readable code may be further configured to obtain a PER associated with the transmission of one or more of the scheduled Bluetooth packets over the Bluetooth link, and to selectively adjust the minTx value based at least in part on the obtained PER. In some instances, execution of the processor-readable code to selectively adjust the minTx value may be configured to decrease the minTx value responsive to the obtained PER being greater than a first PER threshold, or to increase the minTx value responsive to the obtained PER being less than a second PER threshold, the first PER threshold being greater than the second PER threshold.

In some other implementations, execution of the processor-readable code may be further configured to obtain an indication of a signal strength associated with the transmission of one or more of the scheduled Bluetooth packets over the Bluetooth link, and to selectively adjust the minTx value based at least in part on the indication. In various aspects, the indication includes one or more of an RSSI value, an SNR value, an SINR value, or an energy level of a respective Bluetooth packet transmitted over the Bluetooth link. In some instances, execution of the processor-readable code to selectively adjust the minTx value may be further configured to increase the minTx value responsive to the indicated signal strength being greater than a first value, or to decrease the minTx value responsive to the indicated signal strength being less than a second value, the first value being greater than the second value.

Another innovative aspect of the subject matter described in this disclosure can be implemented as a wireless device. In some implementations, the wireless device includes means for scheduling Bluetooth packets for transmission to a peripheral device over a Bluetooth link during an event. The wireless device includes means for obtaining an NSE and a BN for the event, the BN indicating the number of Bluetooth packets scheduled for transmission during the event, the NSE indicating the number of sub-events within the event. The wireless device includes means for obtaining a minimum transmission attempt (minTx) value for the scheduled Bluetooth packets, the minTx value indicating a minimum number of transmission attempts allocated for each of the scheduled Bluetooth packets during the event. The wireless device includes means for determining flush points of the scheduled Bluetooth packets based at least in part on the minTx value, where the number of sub-events between the respective flush points of sequentially scheduled Bluetooth packets is based on the minTx value. The wireless device includes means for transmitting one or more of the scheduled Bluetooth packets over the Bluetooth link during the event based at least in part on the determined flush points. In various implementations, the minTx value is obtained independently of at least one of the NSE or the BN. In some aspects, the Bluetooth link may be one of an LE connected ISO link or an LE broadcast ISO link.

In some instances, the minTx value is equal to 0, and the scheduled Bluetooth packets share a common flush point. In some aspects, the common flush point occurs in a last sub-event of the NSE sub-events. In other instances, the minTx value is equal to 1, and the respective flush points of the scheduled Bluetooth packets occur in a set of contiguous sub-events of the NSE sub-events. In some aspects, the contiguous sub-events correspond to a last number of the NSE sub-events within the event, the last number being equal to BN. In some other instances, the minTx value is equal to 2, and the flush points of the scheduled Bluetooth packets occur in alternating sub-events of the NSE sub-events. In some aspects, the alternating sub-events correspond to a last number of the NSE sub-events within the event, the last number being equal to 2*BN.

In some implementations, the wireless device may also include means for obtaining a PER associated with the transmission of one or more of the scheduled Bluetooth packets over the Bluetooth link, and means for selectively adjusting the minTx value based at least in part on the obtained PER. In some instances, the means for selectively adjusting the minTx value can decrease the minTx value responsive to the obtained PER being greater than a first PER threshold, or can increase the minTx value responsive to the obtained PER being less than a second PER threshold.

In some other implementations, the wireless device may also include means for obtaining an indication of a signal strength associated with the transmission of one or more of the scheduled Bluetooth packets over the Bluetooth link, and means for selectively adjusting the minTx value based at least in part on the indication. In various aspects, the indication includes one or more of an RSSI value, an SNR value, an SINR value, or an energy level of a respective Bluetooth packet transmitted over the Bluetooth link. In some instances, the means for selectively adjusting the minTx value can increase the minTx value responsive to the indicated signal strength being greater than a first value, or can decrease the minTx value responsive to the indicated signal strength being less than a second value, the first value being greater than the second value.

Another innovative aspect of the subject matter described in this disclosure can be implemented as a non-transitory computer-readable storage medium storing instructions, that, when executed by one or more processors of a wireless device, cause the wireless device to perform one or more operations. In some implementations, the one or more operations include scheduling Bluetooth packets for transmission to a peripheral device over a Bluetooth link during an event, and obtaining an NSE and a BN for the event, the BN indicating the number of Bluetooth packets scheduled for transmission during the event, the NSE indicating the number of sub-events within the event. The one or more operations include obtaining a minimum transmission attempt (minTx) value for the scheduled Bluetooth packets, the minTx value indicating a minimum number of transmission attempts allocated for each of the scheduled Bluetooth packets during the event. The one or more operations include determining flush points of the scheduled Bluetooth packets based at least in part on the minTx value, where the number of sub-events between the respective flush points of sequentially scheduled Bluetooth packets is based on the minTx value. The one or more operations include transmitting one or more of the scheduled Bluetooth packets over the Bluetooth link during the event based at least in part on the determined flush points. In various implementations, the minTx value is obtained independently of at least one of the NSE or the BN. In some aspects, the Bluetooth link may be one of an LE connected ISO link or an LE broadcast ISO link.

In some implementations, the one or more operations may also include obtaining a PER associated with the transmission of one or more of the scheduled Bluetooth packets over the Bluetooth link, and selectively adjusting the minTx value based at least in part on the obtained PER. In some instances, the selectively adjusting includes decreasing the minTx value responsive to the obtained PER being greater than a first PER threshold, or increasing the minTx value responsive to the obtained PER being less than a second PER threshold.

In some other implementations, the one or more operations may also include obtaining an indication of a signal strength associated with the transmission of one or more of the scheduled Bluetooth packets over the Bluetooth link, and selectively adjusting the minTx value based at least in part on the indication. In various aspects, the indication includes one or more of an RSSI value, an SNR value, an SINR value, or an energy level of a respective Bluetooth packet transmitted over the Bluetooth link. In some instances, selectively adjusting the minTx value includes increasing the minTx value responsive to the indicated signal strength being greater than a first value, or decreasing the minTx value responsive to the indicated signal strength being less than a second value, the first value being greater than the second value.

Details of one or more implementations of the subject matter described in this disclosure are set forth in the accompanying drawings and the description herein. Other features, aspects, and advantages will become apparent from the description, the drawings, and the claims.

### BRIEF DESCRIPTION OF THE DRAWINGS

FIG. 1 shows a pictorial diagram of an example Wireless Personal Area Network (WPAN), according to various aspects of the present disclosure.

FIG. 2 shows a block diagram of a wireless device, according to various aspects of the present disclosure.

FIG. 3 shows a block diagram of a Bluetooth protocol stack, according to various aspects of the present disclosure.

FIG. 4 depicts an example transmission of a data packet from a wireless device to a peripheral device, according to various aspects of the present disclosure.

FIG. 5 shows a block diagram of another example wireless device, according to various aspects of the present disclosure.

FIG. 6A shows an example assignment of flush points associated with a burst of Bluetooth data.

FIGS. 6B-6D show sequence diagrams for scheduling Bluetooth packets for transmission over a Bluetooth link based on the flush points described with reference to FIG. 6A.

FIG. 7A shows an example assignment of flush points associated with a burst of Bluetooth data, according to various aspects of the present disclosure.

FIGS. 7B-7D show example sequence diagrams for scheduling Bluetooth packets for transmission over a Bluetooth link based on the flush points described with reference to FIG. 7A, according to various aspects of the present disclosure.

FIG. 8A shows another example assignment of flush points associated with a burst of Bluetooth data, according to various aspects of the present disclosure.

FIGS. 8B-8D show example sequence diagrams for scheduling Bluetooth packets for transmission over a Bluetooth link based on the flush points described with reference to FIG. 8A, according to various aspects of the present disclosure.

FIG. 9A shows another example assignment of flush points associated with a burst of Bluetooth data, according to various aspects of the present disclosure.

FIG. 9B shows a sequence diagram for scheduling Bluetooth packets for transmission over a Bluetooth link based on the flush points described with reference to FIG. 9A, according to various aspects of the present disclosure.

FIG. 10 shows a sequence diagram depicting an example wireless communication that supports configuring the flush points associated with a burst of Bluetooth data, according to various aspects of the present disclosure.

FIG. 11 shows a flowchart illustrating an example operation for wireless communication that supports configuring the flush points associated with a burst of Bluetooth data, according to various aspects of the present disclosure.

FIGS. 12A-12B show flowcharts illustrating example operations for wireless communication that supports adjusting the flush points associated with a burst of Bluetooth data, according to various aspects of the present disclosure.

FIGS. 13A-13B show flowcharts illustrating example operations for wireless communication that supports adjusting the flush points associated with a burst of Bluetooth data, according to various aspects of the present disclosure.

FIG. 14 shows a conceptual data flow diagram illustrating the data flow between different means/components in an example apparatus.

FIG. 15 shows a diagram illustrating an example of a hardware implementation for an apparatus employing a processing system.

Like reference numbers and designations in the various drawings indicate like elements.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Communications based on traditional Bluetooth and BLE suffer from several limitations that can limit user experiences and negatively affect user experiences. For example, the range of traditional Bluetooth and BLE is limited by a single hop radio frequency (RF) transmission. Additionally, traditional Bluetooth and BLE have limited data capacity, which can have several negative effects on user experience. For example, the limited data capacity of traditional Bluetooth and BLE can result in limited audio quality or a quality level unacceptable to the user.

To improve the quality and reliability of Bluetooth audio, the Bluetooth specification defines a Bluetooth Low Energy (LE) Audio protocol that allows a wireless device to transmit a Bluetooth audio stream to one or more peripheral devices over an Isochronous (ISO) link that incorporates features of both synchronous links and asynchronous links. For example, when transmitting an audio stream to one or more peripheral devices over an ISO link, the Bluetooth LE Audio protocol allows audio packets of the audio stream to be asynchronously transmitted to the peripheral devices, thereby avoiding synchronization issues between the wireless device and the peripheral devices. The Bluetooth LE Audio protocol also allows a limited number of retransmission attempts by the wireless device if the peripheral devices do not receive, or are unable to successfully decode, one or more of the audio packets transmitted by the wireless device.

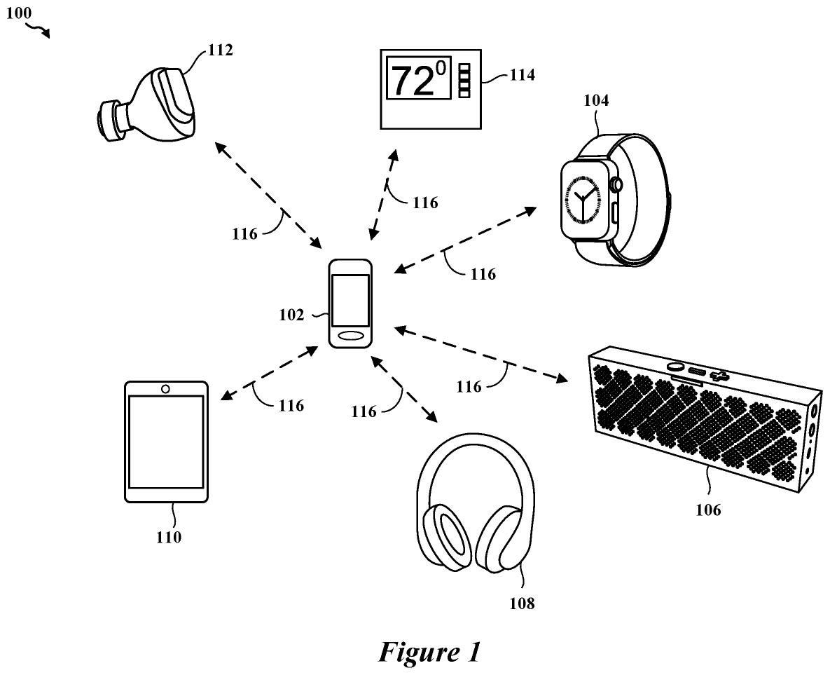

FIG. 1 shows a pictorial diagram of an example Wireless Personal Area Network (WPAN) 100, according to some implementations. Within the WPAN 100, a central device 102 may connect to and establish a BLE communication link 116 with one or more peripheral devices 104, 106, 108, 110, 112, 114 using a BLE protocol or a modified BLE protocol. The BLE protocol is part of the Bluetooth core specification and enables radio frequency communication operating within the globally accepted 2.4 GHz Industrial, Scientific & Medical (ISM) band.

The central device 102 may include suitable logic, circuitry, interfaces, processors, and/or code that may be used to communicate with one or more peripheral devices 104, 106, 108, 110, 112, or 114 using the BLE protocol or the modified BLE protocol as described herein. The central device 102 may operate as an initiator to request establishment of a Link Layer (LL) connection with an intended peripheral device 104, 106, 108, 110, 112, or 114. A Link Manager may be used to control operations between a BToIP application controller in the central device 102 and a BToIP application controller in each of the intended peripheral devices 104, 106, 108, 110, 112, and/or 114.

After a requested link layer connection is established, the central device 102 may become a host device, and the selected or intended peripheral device 104, 106, 108, 110, 112, or 114 may become paired with the central device 102 over the established link layer connection. As a host device, the central device 102 may be capable of supporting multiple link layer connections at a time with various peripheral devices 104, 106, 108, 110, 112, or 114 operating as client devices. Specifically, the central device 102 may manage various aspects of data packet communication in a link layer connection with one or more of the associated peripheral devices 104, 106, 108, 110, 112, or 114. For example, the central device 102 may determine an operation schedule in the link layer connection with one or more peripheral devices 104, 106, 108, 110, 112, or 114. The central device 102 may also initiate a link layer protocol data unit (PDU) exchange sequence over the link layer connection. Link layer connections may be configured to run periodic events in dedicated data channels. The exchange of link layer data PDU transmissions between the central device 102 and one or more of the peripheral devices 104, 106, 108, 110, 112, or 114 may take place within events.

In some implementations, the central device 102 may be configured to transmit the first link layer data PDU in each event to an intended peripheral device 104, 106, 108, 110, 112, or 114. In other implementations, the central device 102 may utilize a polling scheme to poll the intended peripheral device 104, 106, 108, 110, 112, or 114 for a link layer data PDU transmission during an event. The intended peripheral device 104, 106, 108, 110, 112, or 114 may transmit a link layer data PDU upon receipt of packet link layer data PDU from the central device 102. In some other implementations, a peripheral device 104, 106, 108, 110, 112, or 114 may transmit a link layer data PDU to the central device 102 without first receiving a link layer data PDU from the central device 102.

Examples of the central device 102 may include a cellular phone, a smart phone, a session initiation protocol (SIP) phone, a mobile station (STA), a laptop, a personal computer (PC), a desktop computer, a personal digital assistant (PDA), a satellite radio, a global positioning system, a multimedia device, a video device, a digital audio player, a camera, a game console, a tablet, a smart device, a wearable device (such as a smart watch, wireless headphones, etc.), a vehicle, an electric meter, a gas pump, a toaster, a thermostat, a hearing aid, a blood glucose on-body unit, an Internet-of-Things (IoT) device, or any other similarly functioning device.

Examples of the one or more peripheral devices 104, 106, 108, 110, 112, or 114 may include a cellular phone, a smart phone, a SIP phone, a STA, a laptop, a PC, a desktop computer, a PDA, a satellite radio, a global positioning system, a multimedia device, a video device, a digital audio player, a camera, a game console, a tablet, a smart device, a wearable device (such as a smart watch, wireless headphones, etc.), a vehicle, an electric meter, a gas pump, a toaster, a thermostat, a hearing aid, a blood glucose on-body unit, an IoT device, or any other similarly functioning device. Although the central device 102 is illustrated in communication with six peripheral devices 104, 106, 108, 110, 112, or 114 in the WPAN 100, the central device 102 may communicate with more or fewer than six peripheral devices within the WPAN 100 without departing from the scope of the present disclosure.

A device implementing the BT protocol, such as the central device 102, may operate according to one radio mode, such as basic rate (BR)/enhanced data rate (EDR), and a device implementing the BLE protocol may operation according to a BLE radio mode. In some aspects, the central device 102 may be configured with dual radio modes, and therefore may be able to operate according to the BR/EDR mode or the BLE mode, for example, based on the type of short-rage wireless communication in which the device may engage.

For example, the central device 102 may operate according to the BR/EDR mode for continuous streaming of data, for broadcast networks, for mesh networks, and/or for some other applications in which a relatively higher data rate may be more suitable. However, the device may operate according to the BLE mode for short burst data transmissions, such as for some other applications in which power conservation may be desirable and/or a relatively lower data rate may be acceptable. In other aspects, the central device 102 may operate according to one or more other radio modes, including proprietary radio mode(s). Examples of other radio modes may include high speed radio modes, low energy radio modes, isochronous radio modes, etc.

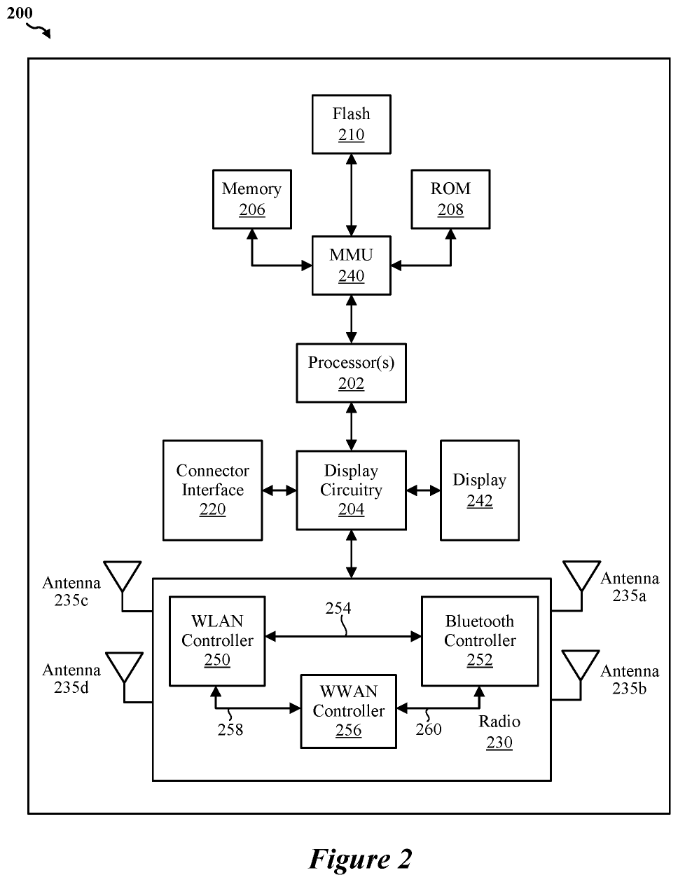

FIG. 2 shows a block diagram of a wireless device 200, according to some implementations. In some instances, the wireless device 200 may be an example of the central device 102 of FIG. 1. In other instances, the wireless device 200 may be an example of one or more of the peripheral devices 104, 106, 108, 110, 112, or 114 of FIG. 1. In some aspects, the wireless device 200 may be a Bluetooth-enabled device (such as a BLE device).

As shown, the wireless device 200 may include a processing element, such as processor(s) 202, which may execute program instructions for the wireless device 200. The wireless device 200 may also include a display 242 that can perform graphics processing and present information to a user. The processor(s) 202 may also be coupled to memory management unit (MMU) 240, which may be configured to receive addresses from the processor(s) 202 and translate the addresses to address locations in memory such as memory 206, ROM 208, or Flash memory 210) and/or to address locations in other circuits or devices, such as the display circuitry 204, radio 230, connector interface 220, and/or display 242. The MMU 240 may also be configured to perform memory protection and page table translation or set up. In some aspects, the MMU 240 may be included as a portion of the processor(s) 202.

The processor(s) 202 may be coupled to other circuits of the wireless device 200. For example, the wireless device 200 may include various types of memory, a connector interface 220 through which the wireless device 200 can communicate with the computer system, and wireless communication subsystems that can transmit data to, and receive data from, other devices based on one or more wireless communication standards or protocols. For example, in some aspects, the wireless communication subsystems may include (but are not limited to) a WLAN subsystem, a Bluetooth subsystem, or a cellular subsystem (such as an LTE or 5G NR subsystem). The wireless device 200 may include a plurality of antennas 235a, 235b, 235c, or 235d for performing wireless communication with, for example, wireless devices in a WPAN.

The wireless device 200 may be configured to implement part or all of the techniques described herein by executing program instructions stored on a memory medium (such as a non-transitory computer-readable memory medium) and/or through hardware or firmware operation. In other embodiments, the techniques described herein may be at least partially implemented by a programmable hardware element, such as an field programmable gate array (FPGA), and/or an application specific integrated circuit (ASIC).

In certain aspects, the radio 230 may include separate controllers configured to control communications for various respective radio access technology (RAT) protocols. For example, as shown in FIG. 2, radio 230 may include a WLAN controller 250 that manages WLAN communications, a Bluetooth controller 252 that manages Bluetooth and BLE communications, and a WWAN controller 256 that manages WWAN communications. In certain aspects, the wireless device 200 may store and execute a WLAN software driver for controlling WLAN operations performed by the WLAN controller 250, a Bluetooth software driver for controlling Bluetooth operations performed by the Bluetooth controller 252, and/or a WWAN software driver for controlling WWAN operations performed by the WWAN controller 256.

In certain implementations, a first coexistence interface 254 (such as a wired interface) may be used for sending information between the WLAN controller 250 and the Bluetooth controller 252. In certain other implementations, a second coexistence interface 258 may be used for sending information between the WLAN controller 250 and the WWAN controller 256. In certain other implementations, a third coexistence interface 260 may be used for sending information between the Bluetooth controller 252 and the WWAN controller 256.

In some aspects, one or more of the WLAN controller 250, the Bluetooth controller 252, and/or the WWAN controller 256 may be implemented as hardware, software, firmware or some combination thereof.

In certain configurations, the WLAN controller 250 may be configured to communicate with a second device in a WPAN using a WLAN link using all of the antennas 235a, 235b, 235c, and 235d. In certain other configurations, the Bluetooth controller 252 may be configured to communicate with at least one second device in a WPAN using one or more of the antennas 235a, 235b, 235c, and 235d. In certain other configurations, the WWAN controller 256 may be configured to communicate with a second device in a WPAN using all of the antennas 235a, 235b, 235c, and 235d. The WLAN controller 250, the Bluetooth controller 252, and/or the WWAN controller 256 may be configured to adjust wakeup time interval and shutdown time for the device.

A short-range wireless communications protocol, such as BT, BLE, and/or BR/EDR, may include and/or may use one or more other communications protocols, for example, for establishing and maintaining communications links. Referring also to FIG. 1, the wireless device 200 may establish a communications link 116 with one or more peripheral devices, such as a wireless headset 112, according to at least one communications protocol for short-range wireless communications.

The communications link 116 may include a communications link that adheres to a protocol included and/or for use with BT, BLE, BR/EDR, etc. In one aspect, the communications link 116 may include an asynchronous connection-less (ACL) link. When operating as an ASL link, the communications link 116 may allow the source device 102 to connect or “pair” with a peripheral device, such as the headset 112. The connection is asynchronous in that the two devices may not need to synchronize, time-wise, data communications between each other to permit communication of data packets via the communications link 116.

A Logical Link Control and Adaptation Protocol (L2CAP) may be used within a BT protocol stack (not shown in FIG. 2 for simplicity). An L2CAP connection may be established after an ACL link has been established. Reference to L2CAP in the present disclosure may be further applicable to enhanced L2CAP (EL2CAP), which may be an enhanced version of the L2CAP protocol that enables multiplexing of multiple logical data channels via a single radio connection.

In one aspect, the communications link 116 may include an Advanced Audio Distribution Profile (A2DP) link. An A2DP link provides a point-to-point link between a source device, such as the source device 102, and a sync device, such as the headset 112. With an A2DP link, data packets including audio may be transmitted over an ACL data channel, and other information, for example, for controlling the audio stream, may be transmitted over a separate control channel. The data packets may occur non-periodically.

In another aspect, the communications link 116 may support synchronous logical transport mechanisms between a source device (such as the source device 102) and a peripheral device (such as the headset 112). For example, the communications link 116 may include a synchronous connection-oriented (SCO) link that provides a symmetric point-to-point link between the source device and the peripheral device using time slots reserved for BT communications. In some aspects, an SCO link may not support retransmission of data packets, which may be unsatisfactory in audio streaming and/or voice use cases in which a dropped audio or voice packet may reduce the quality of the user experience.

In a further aspect, the communications link 116 may include an extended SCO (eSCO) link. An eSCO link may provide a symmetric or asymmetric point-to-point link between a source device and a peripheral device using time slots reserved for BT communications, and may also provide for a retransmission window following the reserved time slots. Because retransmissions may be facilitated using the retransmission window, an eSCO link may be suitable for audio streaming and/or voice use cases because a dropped audio or voice packet may be retransmitted, and therefore the probability of successfully receiving a data packet may be increased.

In one aspect, the communications link 116 may include an Isochronous (ISO) link. When operating as an ISO link, the communications link 116 may combine some features of both synchronous and asynchronous links. For example, a stream on an ISO link may begin with a start packet, and then data packets may be asynchronously transmitted. On an ISO link, the number of retransmission attempts by a transmitting device may be limited. Thus, if a receiving device is unable to decode a data packet within the limited number of retransmission attempts, then the data packet may be dropped and the receiving device may continue to receive the stream without data from the dropped data packet.

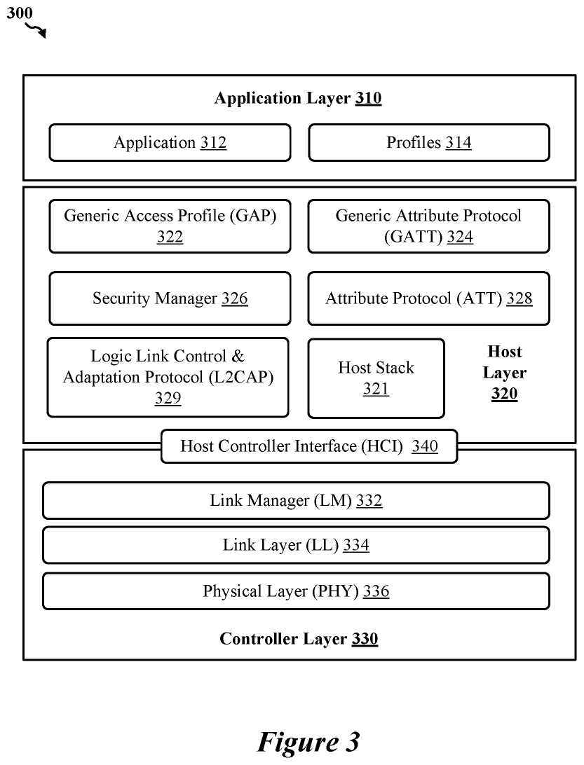

FIG. 3 shows a block diagram of a BT protocol stack 300 that may be implemented in a wireless device (such as the source device 102 or one or more of the peripheral devices 104, 106, 108, 110, or 112 of FIG. 1). For example, the BT protocol stack 300 may be implemented by one or more of processor(s) 202, memory 206, Flash memory 210, ROM 208, the radio 230, and/or the Bluetooth controller 252 illustrated in FIG. 2. The BT protocol stack 300 may be organized into three layers including Application layer 310, a Host layer 320, and a Controller layer 330.

The Application layer 310 may be a user application that interfaces with the other blocks and/or layers of the BT protocol stack 300. In some aspects, the Application layer 310 may include one or more applications 312 and one or more Bluetooth profiles 314 that allow the applications to use the Bluetooth and BLE communications. The Host layer 320 may include the upper layers of the BT protocol stack 300, and may communicate with a controller (such as the Bluetooth controller 252 of FIG. 2) in a wireless device using a Host Controller Interface (HCl) 340. In some aspects, the Host layer 320 may include a host stack 321 that can be used for application layer interface management to allow an application to access Bluetooth communications.

The Controller layer 330 may include the lower layers of the BT protocol stack 300. The Controller layer 330, which may be used for hardware interface management, link establishment, and link management, is shown to include a Link Manager (LM) 332, a Link Layer (LL) 334, and a physical (PHY) layer 336. The PHY layer 336 may include, for example, a radio and/or a baseband processor. In some aspects, the PHY layer 336 may define the mechanism for transmitting a bit stream over a physical link or channel that connects BT devices. The bit stream may be grouped into code words or symbols, and converted to a data packet that is transmitted over a wireless transmission medium. The PHY layer 336 may provide an electrical, mechanical, and/or procedural interface to the wireless transmission medium. The PHY layer 336 may be responsible for modulation and demodulation of data into radio frequency (RF) signals for transmission over the air. The PHY layer 336 may describe the physical characteristics of a wireless device's receiver/transmitter. The physical characteristics may include modulation characteristics, radio frequency tolerance, sensitivity level, etc.

The Link Layer 334 is responsible for low-level communication over the PHY layer 336. The Link Layer 334 334 may also manage the sequence and timing for transmitting and receiving data packets, and using a LL protocol, may communicate with other devices regarding connection parameters and data flow control. In some aspects, the Link Layer 334 also provides gatekeeping functionality to limit exposure and data exchange with other devices. If filtering is configured, the Link Layer 334 maintains a list of allowed devices and will ignore all requests for data exchange from devices not on the list. The Link Layer 334 may also reduce power consumption. In some aspects, the Link Layer 334 may include a company's proprietary LL that may be used to discover peer devices, and establish a secure communication channel therewith. In certain aspects, the Link Layer 334 may be responsible for transporting data packets between devices in a WPAN. Each data packet may include an access address, which specifies the type of logical transport used to carry the data packet. Logical transports may exist between a master device and slave devices. Additionally, some logical transports may carry multiple logical links.

The Link Manager 332 may be responsible for establishing and configuring links and managing power-change requests, among other tasks. Each type of logical link, such as ACL links, A2DP links, SCO links, eSCO links, ISO links, etc., may be associated with a specific packet type. For example, an SCO link may provide reserved channel bandwidth for communication between a master device and a slave device, and support regular, periodic exchange of data packets with no retransmissions. An eSCO link may provide reserved channel bandwidth for communication between a source device and a peripheral device, and support regular, periodic exchange of data packets with retransmissions. An ACL link may exist between a source device and a peripheral device from the beginning of establishment of a connection between the source device and the peripheral device, and the data packets for ACL links may include encoding information in addition to a payload.

The Link Manager 332 may communicate with the Host layer 320 using the HCl 340. In some instances, the Link Manager 332 may translate HCl 340 commands into controller-level operations, such as baseband-level operations. The HCl 340 may act as a boundary between the lower layers (such as between the Controller layer 330, the Host layer 320, and the Application layer 310). The BT specification may define a standard HCl to support BT systems that are implemented across two separate processors. For example, a BT system on a computer may use the BT system's own processor to implement the lower layers of the BT protocol stack 300, such as the PHY layer 336, the Link Layer 334, and/or the Link Manager 332. In some aspects, the BT system may use a processor of a BT component to implement the other layers of the BT protocol stack 300 such as, for example, the Host layer 320 and the Application layer 310.

The Host layer 320 is shown to include a Generic Access Profile (GAP) 322, a Generic attribute Protocol (GATT) 324, a Security Manager (SM) 326, Attribute Protocol (ATT) 328, and a L2CAP layer 329. The GAP 322 may provide an interface for the application 312 to initiate, establish, and manage connections with other BT or BLE devices. The GATT 324 may provide a service framework using the attribute protocol for discovering services, and for reading and writing characteristic values on a peer device. The GATT 324 may interface with the application 312, for example, through a profile which may define a collection of attributes and any permission needed for the attributes to be used in BT or BLE communications.

The Security Manager 326 may be responsible for device pairing and key distribution. A security manager protocol implemented by the Security Manager 326 may define how communications with the Security Manager of a counterpart BLE device are performed. The Security Manager 326 provides additional cryptographic functions that may be used by other components of the BT protocol stack 300. The architecture of the Security Manager 326 used in Bluetooth communications is designed to minimize recourse requirements for peripheral devices by shifting work to an assumingly more powerful central device. BLE uses a pairing mechanism for key distribution. The Security Manager 326 provides a mechanism to not only encrypt the data but also to provide data authentication.

The ATT 328 includes a client/server protocol based on attributes associated with a BLE device configured for a particular purpose. Examples may include monitoring heart rate, temperature, broadcasting advertisements, etc. The attributes may be discovered, read, and written by peer devices. The set of operations which are executed over ATT 328 may include, but are not limited to, error handling, server configuration, find information, read operations, write operations, queued writes, etc. The ATT 328 may form the basis of data exchange between BT and BLE devices.

The L2CAP layer 329 may be implemented above the HCl 340, and may communicate with the controller layer 330 through the HCl 340. The L2CAP layer 329 may be primarily responsible for establishing connections across one or more existing logical links and for requesting additional links if none exist. The L2CAP layer 329 may also implement multiplexing between different higher-layer protocols, for example, to allow different applications to use a single link, such as a logical link, including an ACL link. In some implementations, the L2CAP layer 329 may encapsulate multiple protocols from the upper layers into a data packet format (and vice versa). The L2CAP layer 329 may also break packets with a large data payload from the upper layers into multiple packets with the data payload segmented into smaller size data payloads that fit into a maximum payload size (for example, twenty-seven bytes) on the transmit side.

In some standards and protocols, such as BLE and/or BR/EDR, the source device 102 may detect errors in a packet and/or a dropped/missed/not received packet through the use of cyclic redundancy check (CRC) validation and through the use of message integrity code (MIC) validation. MIC validation may be used when a packet is encrypted. For example, failure of CRC validation may indicate one or more errors in a received packet and failure of MIC validation may indicate that another packet has not been received (although failure of CRC validation may also indicate another packet has not been received and/or failure of MIC validation may also indicate one or more errors in a received packet).

CRC validation and MIC validation may be based on generating CRC values and MICs, respectively, based on received packets and respectively comparing those generated CRC values and MICs to CRC and MICs included in received packets. Specifically, a receiving device, such as the headset 112, that receives a packet may first generate a CRC value or a CRC checksum based on the received packet, such as based on a payload and, if applicable, a MIC included in the received packet. The receiving device may compare the generated CRC value with a CRC value included in the received packet. If the generated CRC value matches the CRC value included in the received packet, then the received packet may be validated for CRC. The CRC-validated received packet may then be decrypted. However, if the generated CRC value does not match the CRC value included in the received packet, then the receiving device may determine that the received packet fails CRC validation. If the receiving device determines the received packet fails CRC validation, then the received packet may include errors and/or may be corrupted. In one configuration, the receiving device may discard the received packet that fails CRC validation; however, in another configuration, the receiving device may attempt to recover the received packet, for example, using one or more error correction techniques.

If the received packet is encrypted and passes CRC validation, then the receiving device may decrypt the received packet to obtain a decrypted payload and a decrypted MIC. For MIC validation, the receiving device may generate a MIC based on the decrypted payload, and compare the generated MIC with the MIC obtained from the decrypted received packet. If the generated MIC matches the decrypted MIC, then the receiving device may determine that the received packet is successfully decrypted. When the received packet is successfully decrypted, the decoded and decrypted payload of the received packet may be provided to another layer of the receiving device, such as a coder-decoder (codec) of the receiving device that may cause the payload data of the received packet to be output by the receiving device, for example, as audio through speakers of the headset 112.

If the generated MIC does not match the decrypted MIC of the received packet, then the receiving device may determine that the received packet is unsuccessfully decrypted. When the received packet is unsuccessfully decrypted, then a different packet may have been missed or the received packet may be erroneous or otherwise corrupted. In one configuration, the receiving device may discard the received packet that fails MIC validation; however, in another configuration, the receiving device may attempt to recover the received packet.

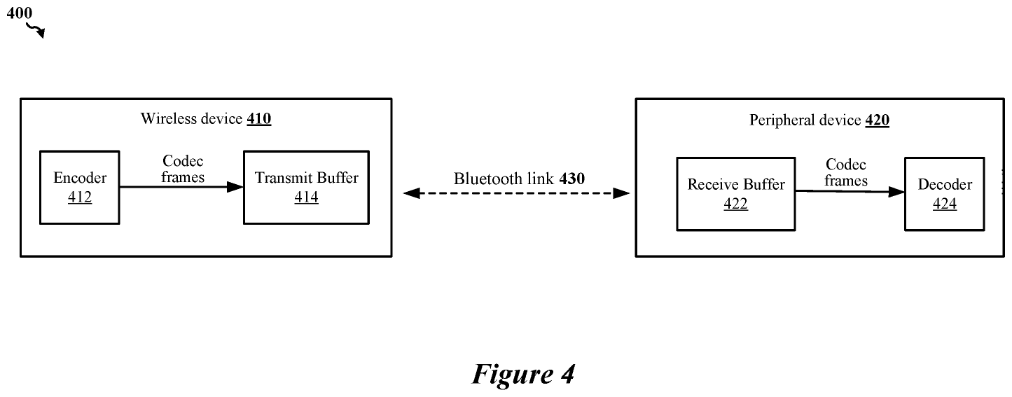

FIG. 4 depicts an example transmission 400 of data packets from a wireless device 410 to a peripheral device 420 over a Bluetooth link 430, according to various aspects of the present disclosure. In some implementations, the wireless device 410 may be one example of the central device 102 of FIG. 1 or the wireless device 200 of FIG. 2, and the peripheral device 420 may be an example of one or more of the peripheral devices 104, 106, 108, 110, 112 or 114 of FIG. 1. In some instances, the peripheral device 420 may be a pair of earbuds. In some aspects, the Bluetooth link 430 may be one of a connected ISO link or a broadcast ISO link.

The wireless device 410 is shown to include an encoder 412 and a transmit buffer 414. The encoder 412 may be configured to encode data, such as audio or video data, using a specified bitrate. The transmit buffer 414 may be configured to queue data packets that are to be transmitted over the Bluetooth link 430 to the peripheral device 420. In some implementations, the data packets to be transmitted over the Bluetooth link 430 may be of a predefined size, for example, based on the type of Bluetooth link 430 and/or channel conditions associated with the Bluetooth link 430. In some aspects, data encoded by the encoder 412 may be packetized into a data packet of a predefined size. The wireless device 410 may de-queue data packets from the transmit buffer 414 and transmit the data packets to the peripheral device 420 over the Bluetooth link 430.

The peripheral device 420 is shown to include a receive buffer 422 and a decoder 424. Data packets received over the Bluetooth link 430 may be queued or otherwise stored in the receive buffer 422. The data packets may be output from the receive buffer 422 and forwarded to the decoder 424. In some aspects, the decoder 424 may decode data (such as audio and/or video data) carried in the payloads of the queued data packets, and forward the decoded data to upper layers of the protocol stack for processing and playback to a user. In some implementations, the encoder 412 may encode a first encoder/decoder (codec) frame using a first bitrate, and forward the first codec frame to the transmit buffer 414 to be packetized for transmission to the peripheral device 420 over the Bluetooth link 430. The peripheral device 420 may queue the received data packet in the receive buffer 422, and may forward the first portion of the first codec frame to the decoder 424 for decoding.

In some implementations, the wireless device 410 and the peripheral device 420 may exchange Bluetooth packets over an LE connected ISO link or an LE broadcast ISO link. For example, in some instances, the wireless device 410 and peripheral device 420 may exchange isochronous data in either direction using a Connected Isochronous Stream (CIS) that carries a single stream of isochronous data either in a single direction or in both directions. The stream of isochronous data is divided into payloads that can be transmitted over the Bluetooth link as Bluetooth PDUs during one or more CIS events. In some instances, each CIS event includes a number of sub-events (NSE) during which the wireless device 410 may transmit Bluetooth packets to the peripheral device 420 over the Bluetooth link, and the peripheral device 420 may send a response (such as an ACK or NACK) to the wireless device 410 over the Bluetooth link 430. In other instances, each CIS event includes a number of sub-events (NSE) during which the peripheral device 420 may transmit Bluetooth packets to the wireless device 410 over the Bluetooth link, and the wireless device 410 may send a response (such as an ACK or NACK) to the peripheral device 420 over the Bluetooth link 430. For instances in which the CIS is bidirectional, some of the sub-events may allow the peripheral device 420 to transmit Bluetooth packets to the wireless device 410 over the Bluetooth link, and the wireless device 410 may send a response (such as an ACK or NACK) to the peripheral device 420 over the Bluetooth link 430.

In other instances, the wireless device 410 may broadcast isochronous data to one or more peripheral devices using a Broadcast Isochronous Stream (BIS) that carries a single stream of broadcast isochronous data. The stream of broadcast isochronous data is divided into payloads that can be transmitted over the Bluetooth link as Bluetooth PDUs during one or more Broadcast Isochronous Group (BIG) events. Each BIG event may include a number of sub-events (NSE) during which the wireless device 410 can broadcast Bluetooth packets over the Bluetooth link to multiple peripheral devices at the same time.

Each event, which may refer to either a CIS event or a BIG event, is associated with a number of parameters including (but not limited to) an ISO interval, a sub-interval, an SE_length, a Max_PDU, a number of sub-events (NSE), a burst number (BN), and a Flush Timeout (FT). The ISO interval is the time between the anchor points of adjacent events. The sub-interval is the time between the start of two consecutive sub-events of a CIS event or a BIG event. The SE_length indicates the maximum length of a sub-event within a CIS event or a BIG event. The Max_PDU indicates the maximum number of bytes that can be carried in each Bluetooth PDU transmitted during a respective sub-event of a CIS event or a BIG event. The NSE indicates the number of sub-events in the CIS event or BIG event. The BN indicates the number of payloads or PDUs of a data burst scheduled for transmission during the CIS event or BIG event. For bidirectional communications, the value of BN may be the same for each direction, or may be different for each direction.

The FT indicates the maximum number of CIS events that may be used to transmit (or retransmit) a given payload. In this way, the FT may indicate the life of the burst in terms of ISO events. For example, when FT=1, any PDUs of the burst that have not been transmitted to and successfully received by the peripheral device are flushed in the associated ISO event. For another example, when FT=2, any PDUs of the burst that have not been transmitted to and successfully received by the peripheral device are flushed in the ISO event immediately following the associated ISO event. In some aspects, the ISO event during which the PDUs of a burst are first transmitted over the Bluetooth link may be referred to as the “starting ISO event,” and the ISO event during which the remaining (not acknowledged) PDUs of the burst are flushed may be referred to as the “ending ISO event.” When transmitting a BIS to another device, the maximum number of BIG events that may be used to transmit (or retransmit) a given payload is indicated by the Pre-Transmission Offset (PTO).

Each payload number has an associated flush point (FP) indicating a point in time at which the corresponding PDU will be discarded by the Link Layer if not successfully delivered. For example, the Link Layer of a transmitting device transmits (or retransmits) each PDU until either an acknowledgement (ACK) is received from the receiving device or the corresponding payload reaches its flush point. The flush points of a burst of Bluetooth data occur in the ending ISO event, for example, as indicated by the value of FT.

The Bluetooth Core Specification specifies that the flush point of a payload number occurs immediately after U subevents in the event with the value of cisEventCounter equal to (E+FT−1), where E=floor(cisPayloadCounter÷BN), and U=NSE−floor(NSE÷BN)×(BN−1−cisPayloadCounter mod BN). That is, U denotes the last sub-event, within a given ISO ending event, during which a corresponding PDU can be transmitted, for example, prior to being flushed in the following sub-event. In this way, the Bluetooth Core Specification may guarantee that each PDU scheduled for transmission during a given event is afforded a minimum number (N) of transmission attempts, for example, where N=floor(NSE÷BN). For example, when an event is associated with NSE=8 and BN=3, N=floor(8÷3)=2. As such, each of the BN=3 Bluetooth packets may be allocated at least N=2 different sub-events for transmission attempts to the peripheral device 420.

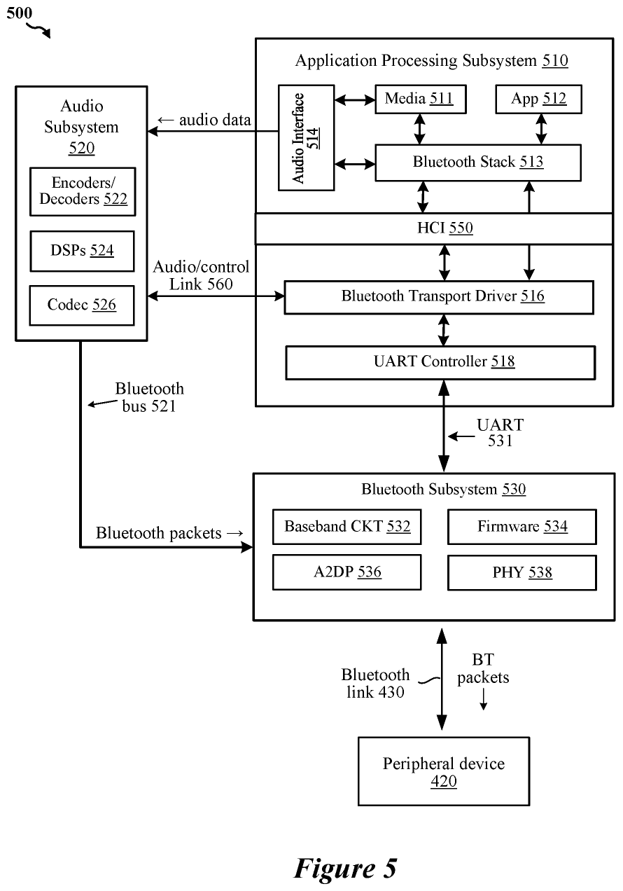

FIG. 5 shows a block diagram of another example wireless device 500, according to various aspects of the present disclosure. In some implementations, the wireless device 500 may be an example of the central device 102 of FIG. 1, the wireless device 200 of FIG. 2, or the wireless device 410 of FIG. 4. In the example of FIG. 5, the wireless device 500 is depicted as having an established Bluetooth link 430 with the peripheral device 420 of FIG. 4. In some aspects, the Bluetooth link 430 may be one of an LE connected ISO link or an LE broadcast ISO link.

The wireless device 500 may include an Application Processing subsystem 510, an audio subsystem 520, a Bluetooth subsystem 530, and a Host Controller Interface (HCl) 550. The Application Processing subsystem 510, which may correspond to at least some portions of the application layer 310 and the Host layer 320 of the BT protocol stack 300 of FIG. 3, is shown to include a media player 511, an Application Layer (App) 512, a Bluetooth stack 513, and an audio interface 514. The media player 511 can be suitable device or component capable of generating or receiving multimedia content including, for example, real-time audio streams, real-time video streams, real-time gaming streams, and other latency-sensitive traffic. The App 512, which may be one implementation of the Application layer 310 FIG. 3, includes at least one Bluetooth profile that defines the collection of attributes and associated permissions to be used in Bluetooth or BLE communications. In some aspects, the App 512 may include processing resources including (but not limited to) the memory 206, the ROM 208, and the Flash memory 210 of FIG. 2. The Bluetooth stack 513 may be one implementation of the BT protocol stack 300 of FIG. 3.

The Bluetooth transport driver 516 may include a split audio and packetization module (not shown for simplicity) that can packetize data (such as audio and/or video data) into Bluetooth frames that can be transmitted to the peripheral device 520 using either a Bluetooth or BLE protocol. The Bluetooth transport driver 516 is connected to the audio subsystem 520 via an audio and control link 560. In some instances, the audio and control link 560 may be used to send encoded audio/video data and control signals between the Bluetooth transport driver 516 and audio/video DSPs within the audio subsystem 520.

The audio subsystem 520 may include encoders/decoders 522, one or more digital signal processors (DSPs) 524, and one or more codecs 526. The encoders/decoders 522 may be used to sample audio/video data extracted from one or more packets received from another wireless device. The extracted audio/video data may be processed in the Application Processing block 510 based at least in part on the Bluetooth profile. In some implementations, the encoders/decoders 522 may partition the sampled audio/video data into payloads that can be embedded within one or more Bluetooth packets for transmission to the peripheral device 520 over a Bluetooth or BLE connection. In some instances, the DSPs 524 and/or the codecs 526 may employ one or more encoding or decoding algorithms in conjunction with sampling the audio data.

The Bluetooth subsystem 530 may include a Bluetooth baseband circuit 532, Bluetooth firmware 534, an advanced audio distribution profile (A2DP) circuit 536, and a PHY 538. The Bluetooth baseband circuit 532 and the Bluetooth firmware 534 may be used to generate baseband signals for constructing and deconstructing data frames based on the Bluetooth or BLE protocol. The baseband circuit 532 and the Bluetooth firmware 534 may also be used to generate carrier signals for up-converting baseband signals during data transmissions and for down-converting received data signals to baseband. The A2DP circuit 536 may be used to control or manage an A2DP link between the wireless device 500 and the peripheral device 420. Specifically, when the Bluetooth subsystem 530 is in a receive mode, the PHY 538 can be used to receive, demodulate, and down-convert data packets received over the Bluetooth link 430, and to forward the data packets to the Application Processing subsystem 510. When the Bluetooth subsystem 530 is in a transmit mode, the PHY 538 can be used to encapsulate data provided from the upper layers into one or more Bluetooth frames or packets for transmission to the peripheral device 420 over the Bluetooth link 430.

In various implementations, the wireless device 500 may schedule a burst of Bluetooth packets for transmission to the peripheral device 420 over the Bluetooth link 430 during an event (such as a CIS event or a BIG event). The wireless device may obtain the NSE, BN, and FT values for the event, and may select, determine, or otherwise obtain the minTx value associated with the burst of Bluetooth packets. In some instances, the minTx value may indicate the minimum number of transmission attempts allocated for each Bluetooth packet included in the burst, and may also indicate the number of sub-events between the respective flush points of sequentially scheduled Bluetooth packets of the burst.

In some implementations, the wireless device 500 may use the minTx value and the FT value to determine the flush points associated with the Bluetooth packets included in the burst of Bluetooth packets. Thereafter, the wireless device 500 may sequentially transmit (or retransmit) the burst of Bluetooth packets over the Bluetooth link 430 to the peripheral device 420 during one or more events. The peripheral device 420 may receive at least some of the Bluetooth packets, and may determine which of the transmitted Bluetooth packets are missing (e.g., transmitted Bluetooth packets that were not received or not successfully decoded by the peripheral device). The peripheral device 420 may transmit one or more ACKs to the wireless device 500 to confirm reception of one or more corresponding Bluetooth packets. In some aspects, the peripheral device 420 may send one or more NACKs to the wireless device 500 to indicate which of the transmitted Bluetooth packets were not received or successfully decoded.

As discussed, the Bluetooth Core Specification allows a central device to ensure a certain minimum number (N) of transmission (or retransmission) attempts for each of the Bluetooth packets in a burst, where N=floor(NSE÷BN). For example, when an event includes NSE=9 sub-events and BN=3, each Bluetooth packet in the burst may be allocated N=floor(NSE÷BN)=floor(9/3)=3 transmission attempts during the event. For another example, when an event includes NSE=8 sub-events and BN=3, each Bluetooth packet in the burst is allocated at least N=floor(NSE÷BN)=floor(8/3)=2 transmission attempts during the event.

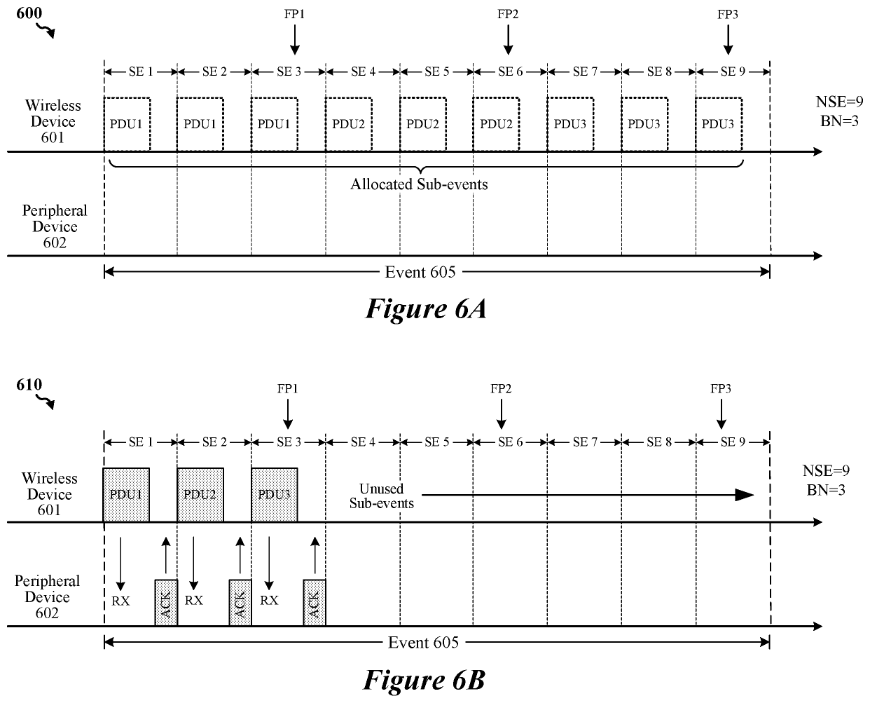

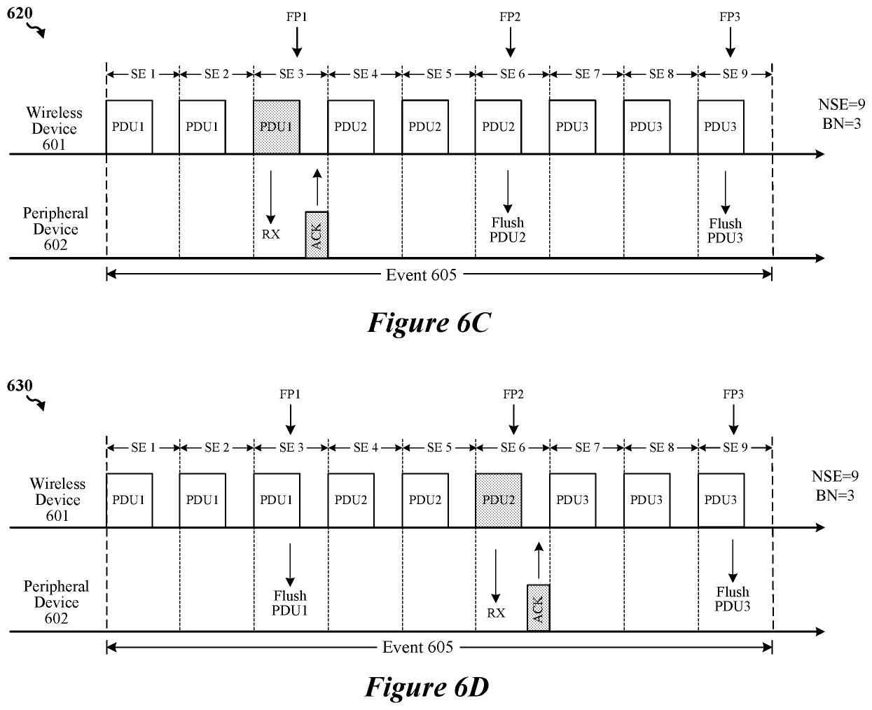

FIG. 6A shows an example assignment 600 of flush points associated with a burst of Bluetooth packets. In the example of FIG. 6A, a wireless device 601 schedules a burst of Bluetooth packets for transmission to a peripheral device 602 over a Bluetooth link during an event 605. The wireless device 601 may be any suitable wireless communication device including, for example, the central device 102 of FIG. 1, the wireless device 200 of FIG. 2, or the wireless device 500 of FIG. 5. The peripheral device 602, which may be paired with the wireless device 601 via the Bluetooth link, may be an example of one or more of the peripheral devices 104, 106, 108, 110, 112, or 114 described with reference to FIG. 1 or the peripheral device 420 of FIGS. 4 and 5.

The event 605 includes NSE=9 sub-events SE1-SE9 during which the wireless device 601 may attempt to transmit BN=3 Bluetooth packets PDU1-PDU3 to the peripheral device 602 over the Bluetooth link. As discussed, the minimum number (N) of transmission attempts allocated to each of the Bluetooth packets PDU1-PDU3 during the event 605 may be expressed as N=floor(NSE÷BN)=9/3=3. In some instances, the wireless device 601 may determine the flush points associated with Bluetooth packets PDU1-PDU3 in a manner specified by the Bluetooth Core Specification. For example, in some aspects, the wireless device 601 may distribute the flush points FP1, FP2, and FP3 associated with respective Bluetooth packets PDU1, PDU2, and PDU3 at fixed intervals across the event 605.

In the example of FIG. 6A, the value of N=3, and thus the flush points FP1-FP3 associated with respective Bluetooth packets PDU1-PDU3 may be configured to occur in every Nth=third sub-event of the event 605, starting at the beginning of the event 605. That is, the flush points associated with Bluetooth packets PDU1-PDU3 may be allocated to corresponding sub-events within the event 605 in the same order as the scheduled transmission of the Bluetooth packets PDU1-PDU3. For example, starting with the first Bluetooth packet PDU1 and the first sub-event SE1, the flush point FP1 associated with PDU1 may be configured to occur during the third sub-event SE3, the flush point FP2 associated with PDU2 may be configured to occur during the sixth sub-event SE6, and the flush point FP3 associated with PDU3 may be configured to occur during the ninth sub-event SE9.

FIG. 6B shows an example sequence diagram for wireless communication 610 that supports transmitting a burst of Bluetooth packets during CIS. The wireless communication 610 may be performed by the wireless device 601 and the peripheral device 602 of FIG. 6A based on the event 605. As discussed, the event 605 includes NSE=9 sub-events SE1-SE9, BN=3, and the flush points FP1, FP2, and FP3 are configured to occur within sub-events SE3, SE6, and SE9, respectively.

For example, the wireless communication 610 may begin with the wireless device 601 transmitting PDU1 to the peripheral device 602 during the first sub-event SE1. The peripheral device 602 receives PDU1, and responds by transmitting an acknowledgement (ACK) confirming reception of PDU1 during sub-event SE1. The wireless device 601 receives the ACK, increments the cisPayloadCounter parameter, and transmits PDU2 to the peripheral device 602 during the second sub-event SE2. The peripheral device 602 receives PDU2, and responds by transmitting an ACK confirming reception of PDU2 during sub-event SE2. The wireless device 601 receives the ACK, increments the cisPayloadCounter parameter, and transmits PDU3 to the peripheral device 602 during the third sub-event SE3. The peripheral device 602 receives PDU3, and responds by transmitting an ACK confirming reception of PDU3 during sub-event SE3.

In the example of FIG. 6B, all of the Bluetooth packets PDU1-PDU3 scheduled for transmission are successfully delivered to the peripheral device 602 during the first three sub-events SE1-SE3. The remaining sub-events SE4-SE9 of the event 605 are not used for transmitting the burst of PDU1-PDU3 to the peripheral device 602, and may be used to exchange other information between the wireless device 601 and the peripheral device 602. In other implementations, the unused sub-events SE4-SE9 may be discarded, for example, by closing the event after the end of sub-event SE3.

FIG. 6C shows another example sequence diagram for wireless communication 620 that supports transmitting a burst of Bluetooth packets during CIS events. The wireless communication 620 may be performed by the wireless device 601 and the peripheral device 602 of FIG. 6A based on the event 605. As discussed, the event 605 includes NSE=9 sub-events SE1-SE9, BN=3, and the flush points FP1, FP2, and FP3 are configured to occur within sub-events SE3, SE6, and SE9, respectively.

For example, the wireless communication 620 may begin with the wireless device 601 transmitting PDU1 to the peripheral device 602 during sub-event SE1. The wireless device 601 does not receive an ACK from the peripheral device 602 during sub-event SE1. In some instances, the peripheral device 602 may not send an ACK frame to confirm reception of a PDU based on a failure of the peripheral device 602 to receive or successfully decode the PDU. In other instances, the peripheral device 602 may receive the PDU during a given sub-event and is unable to transmit a corresponding ACK to the wireless device 601. In some other instances, the peripheral device 602 may receive the PDU during the given sub-event and also transmit an ACK confirming reception of the PDU, and the wireless device 601 may not receive or successfully decode the ACK.

The wireless device 601 responds to the absence of an ACK during sub-event SE1 by retransmitting PDU1 to the peripheral device 602 during sub-event SE2. The wireless device 601 does not receive an ACK from the peripheral device 602 during sub-event SE2. The wireless device 601 responds to the absence of an ACK during sub-event SE2 by retransmitting PDU1 to the peripheral device 602 during sub-event SE3.

The peripheral device 602 receives PDU1 during sub-event SE3, and responds by transmitting an ACK to the wireless device 601. The wireless device 601 receives the ACK, increments the cisPayloadCounter parameter, and transmits PDU2 to the peripheral device 602 during sub-event SE4. The wireless device 601 does not receive an ACK from the peripheral device 602 during sub-event SE4. The wireless device 601 responds by retransmitting PDU2 to the peripheral device 602 during sub-event SE5. The wireless device 601 does not receive an ACK from the peripheral device 602 during sub-event SE5. The wireless device 601 responds by retransmitting PDU2 to the peripheral device 602 during sub-event SE6. The wireless device 601 does not receive an ACK from the peripheral device 602 during sub-event SE6.

The wireless device 601 responds to the absence of an ACK during sub-event SE6 by flushing PDU2 from its transmit buffer based on the flush point FP2 corresponding to PDU2 occurring in sub-event SE6. The wireless device 601 increments the cisPayloadCounter parameter, and transmits PDU3 to the peripheral device 602 during sub-event SE7. The wireless device 601 does not receive an ACK from the peripheral device 602 during sub-event SE7. The wireless device 601 responds by retransmitting PDU3 to the peripheral device 602 during sub-event SE8. The wireless device 601 does not receive an ACK from the peripheral device 602 during sub-event SE8. The wireless device 601 responds by retransmitting PDU3 to the peripheral device 602 during sub-event SE9. The wireless device 601 does not receive an ACK from the peripheral device 602 during sub-event SE9. In response thereto, the wireless device 601 flushes PDU3 from its transmit buffer based on the corresponding flush point FP3 occurring in sub-event SE9 of the event 605.

Thus, in the example of FIG. 6C, the wireless device 601 successfully delivers PDU1 to the peripheral device 602 during sub-event SE3, flushes PDU2 from the transmit buffer during or after sub-event SE6 based on the corresponding flush point FP2 occurring during sub-event SE6, and flushes PDU3 from the transmit buffer during or after sub-event SE9 based on the corresponding flush point FP3 occurring during sub-event SE9.

FIG. 6D shows another example sequence diagram for wireless communication 630 that supports transmitting a burst of Bluetooth packets during CIS events. The wireless communication 630 may be performed by the wireless device 601 and the peripheral device 602 of FIG. 6A based on the event 605. As discussed, the event 605 includes NSE=9 sub-events SE1-SE9, BN=3, and the flush points FP1, FP2, and FP3 are configured to occur within sub-events SE3, SE6, and SE9, respectively.

For example, the wireless communication 630 may begin with the wireless device 601 transmitting PDU1 to the peripheral device 602 during sub-event SE1. The wireless device 601 does not receive an ACK from the peripheral device 602 during sub-event SE1. The wireless device 601 responds to the absence of an ACK during sub-event SE1 by retransmitting PDU1 to the peripheral device 602 during sub-event SE2. The wireless device 601 does not receive an ACK from the peripheral device 602 during sub-event SE2. The wireless device 601 responds by retransmitting PDU1 to the peripheral device 602 during sub-event SE3. The wireless device 601 does not receive an ACK from the peripheral device 602 during sub-event SE3.

The wireless device 601 responds to the absence of an ACK during sub-event SE3 by flushing PDU1 from its transmit buffer during or after sub-event SE3 based on the corresponding flush point FP1 occurring during sub-event SE3. The wireless device 601 increments the cisPayloadCounter parameter, and transmits PDU2 to the peripheral device 602 during sub-event SE4. The wireless device 601 does not receive an ACK from the peripheral device 602 during sub-event SE4. The wireless device 601 responds by retransmitting PDU2 to the peripheral device 602 during sub-event SE5. The wireless device 601 does not receive an ACK from the peripheral device 602 during sub-event SE5. The wireless device 601 responds by retransmitting PDU2 to the peripheral device 602 during sub-event SE6.

The peripheral device 602 receives PDU2 from the wireless device 601 during sub-event SE6, and sends an ACK to confirm reception of PDU2. The wireless device 601 increments the cisPayloadCounter parameter, and transmits PDU3 to the peripheral device 602 during each of the last three sub-events SE7-SE9. The wireless device 601 does not receive any ACKs from the peripheral device 602 during sub-events SE7-SE9, and flushes PDU3 from its transmit buffer during or after sub-event SE9 based on the flush point FP3 associated with PDU3 occurring in sub-event SE9. Thus, in the example of FIG. 6D, the wireless device 601 flushes PDU1 from the transmit buffer after sub-event SE3 based on the corresponding flush point FP1 occurring in sub-event SE3, successfully delivers PDU2 to the peripheral device 602 during sub-event SE6, and flushes PDU3 from the transmit buffer during or after sub-event SE9 based on the corresponding flush point FP3 occurring in sub-event SE9.

Applicant recognizes that distributing the flush points associated with a burst of Bluetooth packets at fixed intervals throughout an event may adversely affect the reliability of Bluetooth transmissions between the wireless device 601 and the peripheral device 602. In accordance with various aspects of the present disclosure, a wireless device (such as a central device) may select or determine the flush points for a burst of Bluetooth packets independently of at least one of the NSE values, the BN values, or the FT values associated with one or more connection events. In some implementations, the flush points associated with a group of PDUs scheduled for transmission over a Bluetooth link may be assigned to sub-events of an ending ISO event in an order that is opposite of the order in which the group of Bluetooth packets is scheduled for transmission over the Bluetooth link. That is, the last PDU of a burst scheduled for transmission during an event is first assigned to the last occurring flush point in the event (e.g., the flush point occurring in the last sub-event of the event), then the second-to-last PDU scheduled for transmission is assigned to the second-to-last occurring flush point in the event (e.g., the flush point occurring in a preceding sub-event), and lastly, the first PDU scheduled for transmission is assigned to the first occurring flush point in the event. In some instances, a wireless device configured according to implementations of the subject matter disclosed herein may select or determine the minimum number of transmission attempts (minTx) to be allocated to each of the scheduled Bluetooth packets, and may determine the flush points based at least in part on the minTx value.

For example, when the minTx value is 1, the flush point associated with the last Bluetooth packet queued in a transmit buffer (such as the Bluetooth PDU having the highest value of cisPayloadNumber) is configured to occur during the last sub-event of the ending ISO event, the flush point associated with the next-to-last Bluetooth packet queued in the transmit buffer (such as the Bluetooth PDU having the next-highest value of cisPayloadNumber) is configured to occur during the next-to-last sub-event of the ending ISO event, the flush point associated with the third-to-last Bluetooth packet queued in the transmit buffer (such as the Bluetooth PDU having the third-highest value of cisPayloadNumber) is configured to occur during the third-to-last sub-event of the ending ISO event, and so on, where the flush point associated with the first Bluetooth packet queued in the transmit buffer (such as the Bluetooth PDU having the lowest value of cisPayloadNumber) is configured to occur in a last of the unallocated sub-events of the ending ISO event. In this way, aspects of the present disclosure may ensure that each Bluetooth packet scheduled for transmission during an event is allocated a certain minimum number of transmission (or retransmission) attempts during an event while also allocating a maximum number unallocated sub-events for transmission (or retransmissions) of the first Bluetooth packet to the peripheral device.

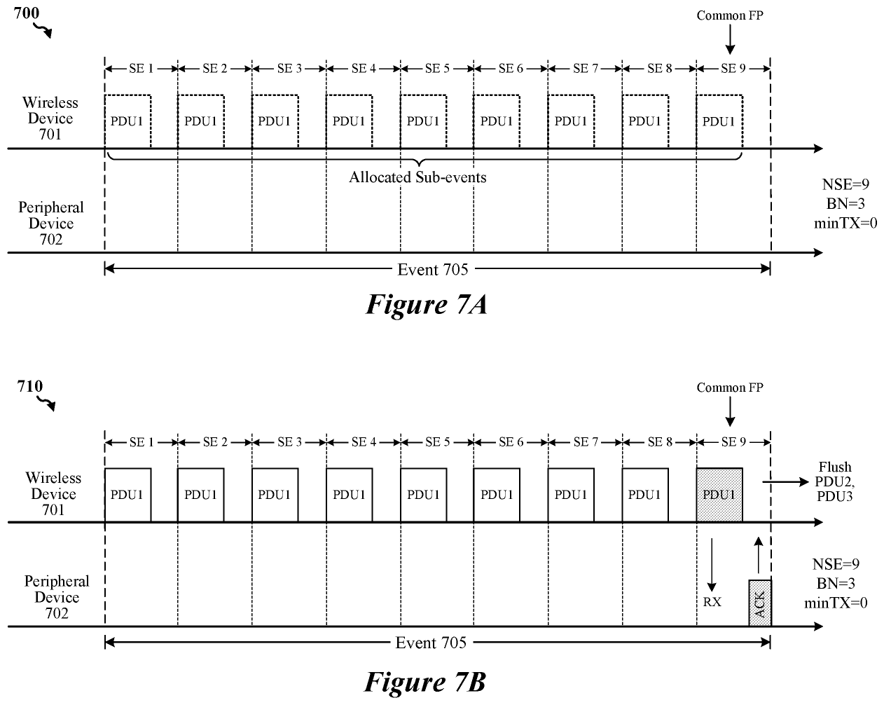

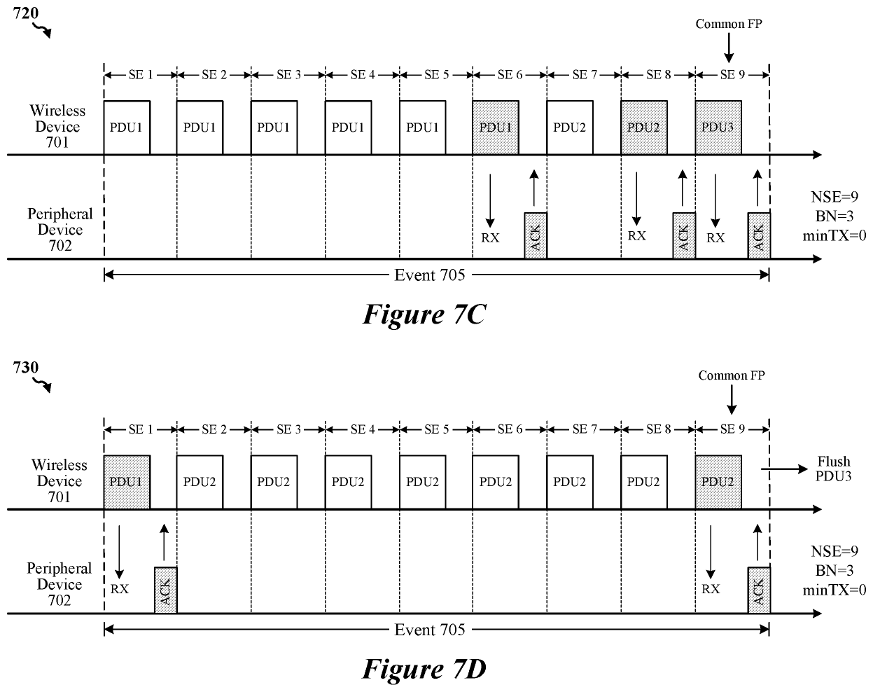

FIG. 7A shows an example assignment 700 of flush points associated with a burst of Bluetooth packets, according to various aspects of the present disclosure. In the example of FIG. 7A, a wireless device 701 schedules a burst of Bluetooth packets for transmission to a peripheral device 702 over a Bluetooth link during an event 705. The wireless device 701 may be any suitable wireless communication device including, for example, the central device 102 of FIG. 1, the wireless device 200 of FIG. 2, or the wireless device 500 of FIG. 5. The peripheral device 702, which may be paired with the wireless device 701 via the Bluetooth link, may be an example of one or more of the peripheral devices 104, 106, 108, 110, 112, or 114 described with reference to FIG. 1 or the peripheral device 420 of FIGS. 4 and 5. In some aspects, the wireless device 701 and peripheral device 702 may be examples of the wireless device 601 and the peripheral device 602 respectively, of FIGS. 6A-6D. In some other implementations, the peripheral device 702 may schedule a burst of Bluetooth packets for transmission to the wireless device 701 over the Bluetooth link during the event 705. In such implementations, the peripheral device 702 may use various aspects of the present disclosure to determine the flush points of a burst of Bluetooth packets queued for transmission to the wireless device 701.

The Bluetooth link may be any suitable link, connection, or channel over which Bluetooth packets and associated control signals can be transmitted. In some instances, the Bluetooth link may be an LE connected ISO link. In other instances, the Bluetooth link may be an LE broadcast ISO link. In some other instances, the Bluetooth link may be one of an asynchronous connection-less (ACL) link, a Logical Link Control and Adaptation Protocol (L2CAP) link, an Advanced Audio Distribution Profile (A2DP) link, or a synchronous connection-oriented (SCO) link.

The event 705 includes NSE=9 sub-events SE1-SE9 during which the wireless device 701 may attempt to transmit BN=3 Bluetooth packets PDU1-PDU3 to the peripheral device 702 over the Bluetooth link. In various implementations, the flush points for Bluetooth packets scheduled for transmission during events (such as CIS events) may be based on the value of minTx. For example, in the example of FIG. 7A, the wireless device 701 configures minTx to a value of 0 (minTx=0), and thereby sets the minimum number of guaranteed transmission attempts for each of the Bluetooth packets PDU1-PDU3 during the event 705 to zero. In this way, the wireless device 701 does not allocate or reserve any of the sub-events SE1-SE9 of the event 705 for transmission of the second and third Bluetooth packets PDU2 and PDU3, respectively.

In some implementations, the wireless device 701 configures the flush point FP3 associated with the last PDU3 to occur in the last sub-event SE9 of the event 705, configures the flush point FP2 associated with PDU2 to occur in the NSE−(1)*minTx=9−(1)*(0)=9^{th} sub-event SE9 of the event 705, and configures the flush point FP1 associated with PDU1 to occur in the NSE−(2)*minTx=9−(2)*(0)=9^{th} sub-event SE9 of the event 705. That is, since the minTx value=0, the wireless device 701 does not allocate or reserve any sub-events within the event 705 for the last BN−1=2 Bluetooth packets PDU2 and PDU3, and therefore the flush points FP1-FP3 associated with respective Bluetooth packets PDU1-PDU3 are the same. As such, all of the Bluetooth packets PDU1-PDU3 scheduled for transmission during the event 705 share a common flush point occurring in the last sub-event SE9 of the event 705.

FIG. 7B shows an example sequence diagram for wireless communication 710 that supports transmitting a burst of Bluetooth packets during CIS events, according to some implementations. The wireless communication 710 may be performed by the wireless device 701 and the peripheral device 702 of FIG. 7A based on the event 705. As discussed, the event 705 includes NSE=9 sub-events SE1-SE9, BN=3, minTx value=0, and a common flush point occurring in sub-event SE9. In some other implementations, the wireless communication 710 may be performed by the peripheral device 702 in conjunction with the transmission of a burst of Bluetooth packets to the wireless device 701 over the Bluetooth link during the event 705. In such implementations, the peripheral device 702 may use various aspects of the present disclosure to determine the common flush point of the burst.

For example, the wireless communication 710 may begin with the wireless device 701 transmitting PDU1 to the peripheral device 702 over the Bluetooth link during sub-event SE1. The wireless device 701 does not receive an ACK from the peripheral device 702 during sub-event SE1. In some instances, the peripheral device 702 may not send an ACK frame to confirm reception of a PDU based on a failure of the peripheral device 702 to receive or successfully decode the PDU. In other instances, the peripheral device 702 may receive the PDU during a given sub-event and is unable to transmit a corresponding ACK to the wireless device 701. In some other instances, the peripheral device 702 may receive the PDU during the given sub-event and also transmit an ACK confirming reception of the PDU, and the wireless device 701 may not receive or successfully decode the ACK.

In response to the absence of an ACK from the peripheral device 702, the wireless device 701 retransmits PDU1 to the peripheral device 702 during sub-event SE2. The operation continues with the wireless device 701 failing to receive ACKs confirming reception of the retransmissions of PDU1 during sub-events SE2-SE8. Then, during sub-event SE9, the peripheral device 702 receives the retransmission of PDU1 from the wireless device 701, and responds by transmitting an ACK to the wireless device 701.

The wireless device 701 receives the ACK, and flushes PDU2 and PDU3 during or after sub-event SE9 based on the common flush point for the Bluetooth packets occurring in sub-event SE9. Thus, in the example of FIG. 7B, setting minTx=0 allows the first Bluetooth packet PDU1 to consume all of the sub-events SE1-SE9 of the event 705, thereby resulting in Bluetooth packets PDU2 and PDU3 being discarded from the transmit buffer in sub-event SE9.

FIG. 7C shows another example sequence diagram for wireless communication 720 that supports transmitting a burst of Bluetooth packets during CIS events, according to some implementations. The wireless communication 720 may be performed by the wireless device 701 and the peripheral device 702 of FIG. 7A based on the event 705. As discussed, the event 705 includes NSE=9 sub-events SE1-SE9, BN=3, minTx value=0, and a common flush point occurring in sub-event SE9. In some other implementations, the wireless communication 720 may be performed by the peripheral device 702 in conjunction with the transmission of a burst of Bluetooth packets to the wireless device 701 over the Bluetooth link during the event 705. In such implementations, the peripheral device 702 may use various aspects of the present disclosure to determine the common flush point of the burst.

For example, the wireless communication 720 may begin with the wireless device 701 transmitting PDU1 to the peripheral device 702 over the Bluetooth link during sub-event SE1. The wireless device 701 does not receive an ACK from the peripheral device 702 during sub-event SE1. In response to the absence of an ACK from the peripheral device 702, the wireless device 701 retransmits PDU1 to the peripheral device 702 during sub-event SE2. The operation continues with the wireless device 701 failing to receive ACKs confirming reception of the retransmissions of PDU1 during sub-events SE2-SE5. Then, during sub-event SE6, the peripheral device 702 receives the retransmission of PDU1 from the wireless device 701, and responds by transmitting an ACK to the wireless device 701 during sub-event SE6.

The wireless device 701 receives the ACK, increments the cisPayloadCounter parameter, and transmits PDU2 to the peripheral device 702 during sub-event SE7. The wireless device 701 does not receive an ACK from the peripheral device 702 during sub-event SE7. The wireless device 701 responds by retransmitting PDU2 to the peripheral device 702 during sub-event SE8. The peripheral device 702 receives PDU2 during sub-event SE8, and sends an ACK to confirm reception of PDU2. The wireless device 701 receives the ACK, increments the cisPayloadCounter parameter, and transmits PDU3 to the peripheral device 702 during sub-event SE9. The peripheral device 702 receives PDU3, and sends an ACK to confirm reception of PDU3. Thus, in the example of FIG. 7C, all of the Bluetooth packets PDU1-PDU3 scheduled for transmission are successfully delivered to the peripheral device 702 during the event 705.

FIG. 7D shows another example sequence diagram for wireless communication 730 that supports transmitting a burst of Bluetooth packets during CIS events, according to some implementations. The wireless communication 730 may be performed by the wireless device 701 and the peripheral device 702 of FIG. 7A based on the event 705. As discussed, the event 705 includes NSE=9 sub-events SE1-SE9, BN=3, minTx value=0, and a common flush point occurring in sub-event SE9. In some other implementations, the wireless communication 710 may be performed by the peripheral device 702 in conjunction with the transmission of a burst of Bluetooth packets to the wireless device 701 over the Bluetooth link during the event 705. In such implementations, the peripheral device 702 may use various aspects of the present disclosure to determine the common flush point of the burst.

For example, the wireless communication 730 may begin with the wireless device 701 transmitting PDU1 to the peripheral device 702 over the Bluetooth link during sub-event SE1. The peripheral device 702 receives PDU1, and responds by transmitting an ACK to the wireless device 701 during sub-event SE1. The wireless device 701 receives the ACK, increments the cisPayloadCounter parameter, and transmits PDU2 to the peripheral device 702 during sub-event SE2. The wireless device 701 does not receive an ACK from the peripheral device 702 during sub-event SE2. In response to the absence of an ACK from the peripheral device 702, the wireless device 701 retransmits PDU2 to the peripheral device 702 during sub-event SE3. The operation continues with the wireless device 701 failing to receive ACKs confirming reception of the retransmissions of PDU1 during sub-events SE3-SE8. Then, during sub-event SE9, the peripheral device 702 receives the retransmission of PDU2 from the wireless device 701, and sends an ACK to confirm reception of PDU3.

The wireless device 701 receives the ACK, increments the cisPayloadCounter parameter, and flushes PDU3 during or after sub-event SE9 based on the common flush point for PDU3 occurring in sub-event SE9. Thus, in the example of FIG. 7D, setting minTx=0 allows the second Bluetooth packet PDU2 to “inherit” the sub-events SE2-SE9 that were not used by the first Bluetooth packet PDU1. As shown, transmissions and retransmissions of the second Bluetooth packet PDU2 occupy all of the remaining sub-events SE2-SE9, thereby causing the wireless device 701 to discard the last Bluetooth packet PDU3 during the last sub-event SE9 of the event 705.

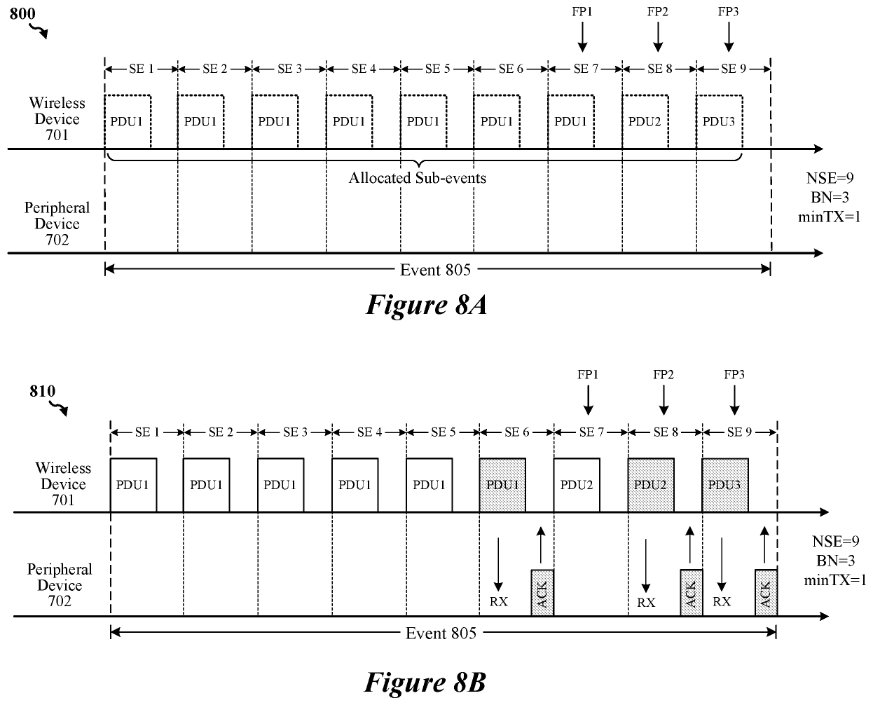

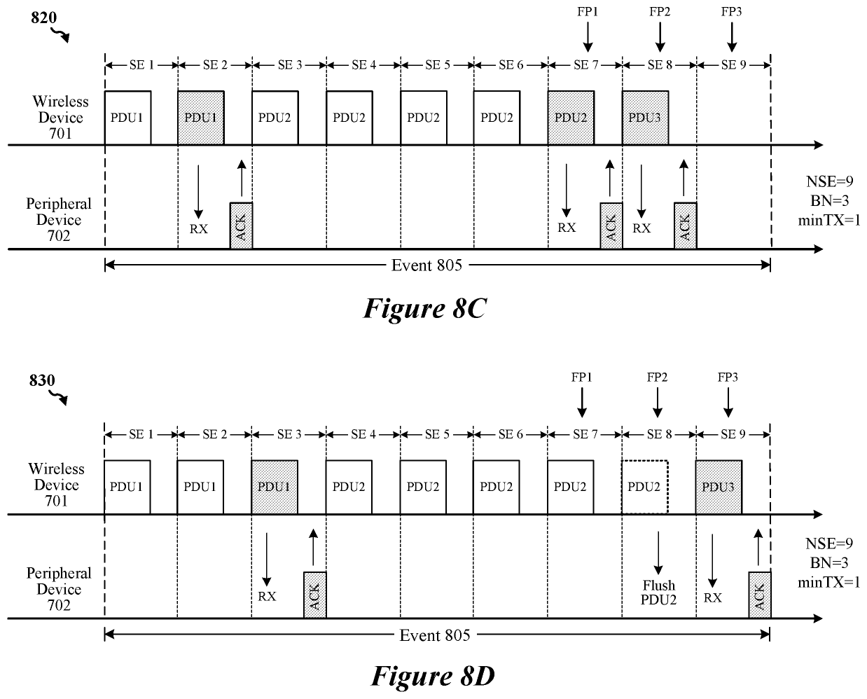

FIG. 8A shows another example assignment 800 of flush points associated with a burst of Bluetooth packets, according to various aspects of the present disclosure. In the example of FIG. 8A, the wireless device 701 schedules a burst of Bluetooth packets for transmission to the peripheral device 702 over a Bluetooth link during an event 805. The event 805 includes NSE=9 sub-events SE1-SE9 during which the wireless device 701 may attempt to transmit BN=3 Bluetooth packets PDU1-PDU3 to the peripheral device 702 over the Bluetooth link. In some other implementations, the peripheral device 702 may schedule a burst of Bluetooth packets for transmission to the wireless device 701 over the Bluetooth link during the event 805. In such implementations, the peripheral device 702 may use various aspects of the present disclosure to determine the flush points of a burst of BN=3 Bluetooth packets queued for transmission to the wireless device 701.

In various implementations, the flush points for Bluetooth packets scheduled for transmission during events (such as CIS events) may be based on the value of minTx. For example, in the example of FIG. 8A, the wireless device 701 configures minTx to a value of 1 (minTx=1), and thereby sets the minimum number of guaranteed transmission attempts for each of the Bluetooth packets PDU1-PDU3 during the event 805 to one. In this way, the wireless device 701 may allocate or reserve one sub-event within the event 805 for each of the Bluetooth packets PDU1-PDU3.

In some implementations, the wireless device 701 configures the flush point FP3 associated with the last PDU3 to occur in the last sub-event SE9 of the event 805, configures the flush point FP2 associated with PDU2 to occur in the NSE−(1)*minTx=9−(1)*(1)=8^{th} sub-event SE8 of the event 805, and configures the flush point FP1 associated with PDU1 to occur in the NSE−(2)*minTx=9−(2)*(1)=7^{th} sub-event SE7 of the event 805. That is, since the minTx value=1, the wireless device 701 allocates or reserves at least one sub-event within the event 805 for each of the Bluetooth packets PDU1-PDU3. In this way, the respective flush points FT1-FP3 associated with PDU1-PDU3 occur in the last BN=3 contiguous sub-events SE7-SE9 of the event 805, thereby allowing the wireless device 701 to use the first 7 sub-events SE1-SE7 of the event 805 (if necessary) to transmit (or retransmit) PDU1 to the peripheral device 802.

FIG. 8B shows an example sequence diagram for wireless communication 810 that supports transmitting a burst of Bluetooth packets during CIS events, according to other implementations. The wireless communication 810 may be performed by the wireless device 701 and the peripheral device 702 of FIG. 8A based on the event 805. As discussed, the event 805 includes NSE=9 sub-events SE1-SE9, BN=3, minTx=1, and flush points FP1-FP3 occurring in the last 3 sub-events SE7-SE9 of the event 805. In some other implementations, the wireless communication 810 may be performed by the peripheral device 702 in conjunction with the transmission of a burst of Bluetooth packets to the wireless device 701 over the Bluetooth link during the event 805. In such implementations, the peripheral device 702 may use various aspects of the present disclosure to determine the flush points of the burst when NSE=9, BN=3, and minTx=1.

For example, the wireless communication 810 may begin with the wireless device 701 transmitting PDU1 to the peripheral device 702 over the Bluetooth link during the first sub-event SE1. The wireless device 701 does not receive an ACK from the peripheral device 702 during sub-event SE1. In some instances, the peripheral device 702 may send a NACK frame, to the wireless device 701, indicating one or more PDUs (or fragments of PDUs) that were not received or successfully decoded by the peripheral device 702. In other instances, the peripheral device 702 may receive the PDU during a given sub-event and is unable to transmit a corresponding ACK to the wireless device 701. In some other instances, the peripheral device 702 may receive the PDU during the given sub-event and also transmit an ACK confirming reception of the PDU, and the wireless device 701 may not receive or successfully decode the ACK (e.g., due to poor channel conditions, interference from other wireless devices, network congestion, low transmit power, etc.).

In response to the absence of an ACK from the peripheral device 702, the wireless device 701 retransmits PDU1 to the peripheral device 702 during sub-event SE2. The operation continues with the wireless device 701 failing to receive ACKs confirming reception of the retransmissions of PDU1 during sub-events SE2-SE5. Then, during sub-event SE6, the peripheral device 702 receives the retransmission of PDU1 from the wireless device 701, and responds by sending an ACK to confirm reception of PDU1.

The wireless device 701 receives the ACK, increments the cisPayloadCounter parameter, and transmits PDU2 to the peripheral device 702 during sub-event SE7. The wireless device 701 does not receive an ACK from the peripheral device 702 during sub-event SE7. The wireless device 701 responds by retransmitting PDU2 to the peripheral device 702 during sub-event SE8. The peripheral device 702 receives PDU2 during sub-event SE8, and sends an ACK to confirm reception of PDU2. The wireless device 701 receives the ACK, increments the cisPayloadCounter parameter, and transmits PDU3 to the peripheral device 702 during sub-event SE9. The peripheral device 702 receives PDU3, and sends an ACK to confirm reception of PDU3. Thus, in the example of FIG. 8B, all of the Bluetooth packets PDU1-PDU3 are successfully delivered to the peripheral device 702 during the event 805.

FIG. 8C shows another example sequence diagram for wireless communication 820 that supports transmitting a burst of Bluetooth packets during CIS events, according to other implementations. The wireless communication 820 may be performed by the wireless device 701 and the peripheral device 702 of FIG. 8A based on the event 805. As discussed, the event 805 includes NSE=9 sub-events SE1-SE9, BN=3, minTx=1, and flush points FP1-FP3 occurring in the last 3 sub-events SE7-SE9. In some other implementations, the wireless communication 820 may be performed by the peripheral device 702 in conjunction with the transmission of a burst of Bluetooth packets to the wireless device 701 over the Bluetooth link during the event 805. In such implementations, the peripheral device 702 may use various aspects of the present disclosure to determine the flush points of the burst when NSE=9, BN=3, and minTx=1.

For example, the wireless communication 820 may begin with the wireless device 701 transmitting PDU1 to the peripheral device 702 over the Bluetooth link during sub-event SE1. The wireless device 701 does not receive an ACK from the peripheral device 702 during sub-event SE1. The wireless device 701 responds by retransmitting PDU1 to the peripheral device 702 during sub-event SE2. The peripheral device 702 receives PDU1, and sends an ACK to confirm reception of PDU1 during sub-event SE2.

The wireless device 701 receives the ACK, and increments the cisPayloadCounter parameter. The successful delivery of PDU1 to the peripheral device 702 used only the first two sub-events SE1-SE2, and thus the second Bluetooth packet PDU2 may inherit the remaining sub-events that were not used for the transmission of PDU1. The wireless device 701 transmits PDU2 to the peripheral device 702 during sub-event SE3. The wireless device 701 does not receive an ACK from the peripheral device 702 during sub-event SE3. The wireless device 701 responds by retransmitting PDU2 to the peripheral device 702 during sub-event SE4. The operation continues with the wireless device 701 failing to receive ACKs confirming reception of the retransmissions of PDU2 during sub-events SE4-SE6. Then, during sub-event SE7, the peripheral device 702 receives the retransmission of PDU2 from the wireless device 701, and sends an ACK to confirm reception of PDU2 during sub-event SE7.

The wireless device 701 receives the ACK, increments the cisPayloadCounter parameter, and transmits PDU3 to the peripheral device 702 during sub-event SE8. The peripheral device 702 receives PDU3, and sends an ACK to confirm reception of PDU3 during sub-event SE8. Thus, in the example of FIG. 8C, all of the Bluetooth packets PDU1-PDU3 are successfully delivered to the peripheral device 702 during the event 805, and the last sub-event SE9 is not used.

FIG. 8D shows another example sequence diagram for wireless communication 830 that supports transmitting a burst of Bluetooth packets during CIS events, according to other implementations. The wireless communication 830 may be performed by the wireless device 701 and the peripheral device 702 of FIG. 8A based on the event 805. As discussed, the event 805 includes NSE=9 sub-events SE1-SE9, BN=3, minTx=1, and flush points FP1-FP3 occurring in the last 3 sub-events SE7-SE9. In some other implementations, the wireless communication 830 may be performed by the peripheral device 702 in conjunction with the transmission of a burst of Bluetooth packets to the wireless device 701 over the Bluetooth link during the event 805. In such implementations, the peripheral device 702 may use various aspects of the present disclosure to determine the flush points of the burst when NSE=9, BN=3, and minTx=1.

For example, the wireless communication 830 may begin with the wireless device 701 transmitting PDU1 to the peripheral device 702 over the Bluetooth link during sub-event SE1. The wireless device 701 does not receive an ACK from the peripheral device 702 during sub-event SE1. The wireless device 701 responds by retransmitting PDU1 to the peripheral device 702 during sub-event SE2. The wireless device 701 does not receive an ACK from the peripheral device 702 during sub-event SE2. The wireless device 701 responds by retransmitting PDU1 to the peripheral device 702 during sub-event SE3. The peripheral device 702 receives PDU1 during sub-event SE3, and responds by transmitting an ACK to the wireless device 701.

The wireless device 701 receives the ACK, increments the cisPayloadCounter parameter, and transmits PDU2 to the peripheral device 702 during sub-event SE4. The wireless device 701 does not receive an ACK from the peripheral device 702 during sub-event SE4. The wireless device 701 responds by retransmitting PDU2 to the peripheral device 702 during sub-event SE5. The operation continues with the wireless device 701 failing to receive ACKs confirming reception of the retransmissions of PDU2 during sub-events SE5-SE8. Since the flush point FP2 associated with PDU2 occurs in sub-event SE8, the wireless device 701 flushes PDU2 from the transmit buffer during or after sub-event SE8.

The wireless device 701 increments the cisPayloadCounter parameter, and transmits PDU3 to the peripheral device 702 during sub-event SE9. The peripheral device 702 receives PDU3, and responds by transmitting an ACK to the wireless device 701. The wireless device 701 receives the ACK, and may update its cisPayloadCounter parameter. Thus, in the example of FIG. 8D, the first Bluetooth packet PDU1 is successfully delivered to the peripheral device 702 during sub-event SE3, the second Bluetooth packet PDU2 is flushed at or after sub-event SE8, and the last Bluetooth packet PDU3 is successfully delivered to the peripheral device 702 during sub-event SE9 of the event 805.

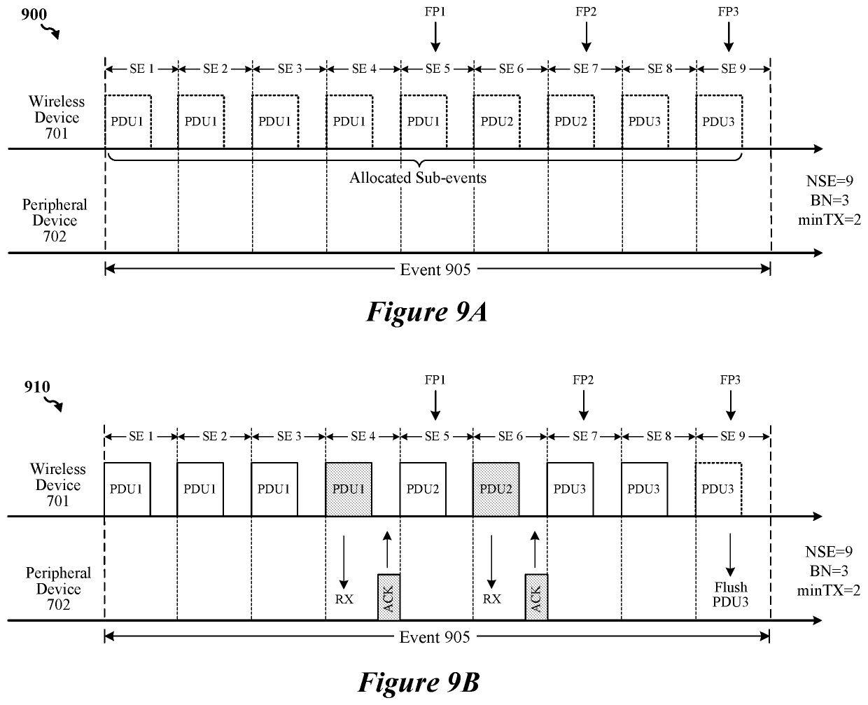

FIG. 9A shows an example assignment 900 of flush points associated with a burst of Bluetooth packets, according to some other implementations. In the example of FIG. 9A, the wireless device 701 schedules a burst of Bluetooth packets for transmission to the peripheral device 702 over a Bluetooth link during an event 905. The event 905 includes NSE=9 sub-events SE1-SE9 during which the wireless device 701 may attempt to transmit BN=3 Bluetooth packets PDU1-PDU3 to the peripheral device 702 over the Bluetooth link. In some other implementations, the peripheral device 702 may schedule a burst of Bluetooth packets for transmission to the wireless device 701 over the Bluetooth link during the event 905. In such implementations, the peripheral device 702 may use various aspects of the present disclosure to determine the flush points of a burst of BN=3 Bluetooth packets queued for transmission to the wireless device 701.

In various implementations, the flush points for Bluetooth packets scheduled for transmission during events (such as CIS events) may be based on the value of minTx. For example, in the example of FIG. 9A, the wireless device 701 configures minTx to a value of 2 (minTx=2), and thereby sets the minimum number of guaranteed transmission attempts for each of the Bluetooth packets PDU1-PDU3 during the event 905 to two. In this way, the wireless device 701 may allocate or reserve two sub-events within the event 905 for each of the Bluetooth packets PDU1-PDU3.

In some implementations, the wireless device 701 configures the flush point FP3 associated with the last PDU3 to occur in the last sub-event SE9 of the event 905, configures the flush point FP2 associated with PDU2 to occur in the NSE−(1)*minTx=9−(1)*(2)=7^{th} sub-event SE7 of the event 905, and configures the flush point FP1 associated with PDU1 to occur in the NSE−(2)*minTx=9−(2)*(2)=5^{th} sub-event SE5 of the event 905. That is, since the minTx value=2, the wireless device 701 allocates or reserves at least two sub-events within the event 905 for each of the Bluetooth packets PDU1-PDU3. As such, the respective flush points FT1-FP3 associated with PDU1-PDU3 are configured to occur in a set of alternating sub-events spanning the last 5 sub-events SE5-SE9 of the event 905. The first Bluetooth packet PDU1 is the first scheduled transmission, and therefore may use the first 5 sub-events SE1-SE5 of the event 905 (if necessary) for transmission to the peripheral device 902.

FIG. 9B shows an example sequence diagram for wireless communication 910 that supports transmitting a burst of Bluetooth packets during CIS events, according to some other implementations. The wireless communication 910 may be performed by the wireless device 701 and the peripheral device 702 of FIG. 9A based on the event 905. As discussed, the event 905 includes NSE=9 sub-events SE1-SE9, BN=3, minTx=2, and flush points FP1, FP2, and FP3 occurring in sub-events SE5, SE7, and SE9, respectively. In some other implementations, the wireless communication 910 may be performed by the peripheral device 702 in conjunction with the transmission of a burst of Bluetooth packets to the wireless device 701 over the Bluetooth link during the event 805. In such implementations, the peripheral device 702 may use various aspects of the present disclosure to determine the flush points of the burst when NSE=9, BN=3, and minTx=2.

For example, the wireless communication 910 may begin with the wireless device 701 transmitting PDU1 to the peripheral device 702 over the Bluetooth link during the first sub-event SE1. The wireless device 701 does not receive an ACK from the peripheral device 702 during sub-event SE1. In some instances, the peripheral device 702 may send a NACK frame, to the wireless device 701, indicating one or more PDUs (or fragments of PDUs) that were not received or successfully decoded by the peripheral device 702. In other instances, the peripheral device 702 may receive the PDU during a given sub-event and is unable to transmit a corresponding ACK to the wireless device 701. In some other instances, the peripheral device 702 may receive the PDU during the given sub-event and also transmit an ACK confirming reception of the PDU, and the wireless device 701 may not receive or successfully decode the ACK (e.g., due to poor channel conditions, interference from other wireless devices, network congestion, low transmit power, etc.).

The wireless device 701 responds to the absence of an ACK during sub-event SE1 by retransmitting PDU1 to the peripheral device 702 during sub-event SE2. The operation continues with the wireless device 701 failing to receive ACKs confirming reception of the retransmissions of PDU1 during sub-events SE2-SE3. Then, during sub-event SE4, the peripheral device 702 receives the retransmission of PDU1 from the wireless device 701, and responds by transmitting an ACK to the wireless device 701 during sub-event SE4.

The wireless device 701 receives the ACK, increments the cisPayloadCounter parameter, and transmits PDU2 to the peripheral device 702 during sub-event SE5. The wireless device 701 does not receive an ACK from the peripheral device 702 during sub-event SE5. The wireless device 701 responds by retransmitting PDU2 to the peripheral device 702 during sub-event SE6. The peripheral device 702 receives PDU2, and responds by transmitting an ACK to the wireless device 701 during sub-event SE6.

The wireless device 701 receives the ACK, increments the cisPayloadCounter parameter, and transmits PDU3 to the peripheral device 702 during sub-event SE7. The wireless device 701 does not receive an ACK from the peripheral device 702 during sub-event SE7. The wireless device 701 responds by retransmitting PDU3 to the peripheral device 702 during sub-event SE8. The wireless device 701 does not receive an ACK from the peripheral device 702 during sub-event SE8. The wireless device 701 responds by retransmitting PDU3 to the peripheral device 702 during sub-event SE9.

The wireless device 701 does not receive an ACK from the peripheral device 702 during sub-event SE9. The wireless device 701 responds by flushing PDU3 from its transmit buffer based on the corresponding flush point FP3 occurring in sub-event SE9 of the event. Thus, in the example of FIG. 9B, the first Bluetooth packet PDU1 is successfully delivered to the peripheral device 702 during sub-event SE4, the second Bluetooth packet PDU2 is successfully delivered to the peripheral device 702 during sub-event SE6, and the last Bluetooth packet PDU3 is flushed during or after sub-event SE9 of the event 805.

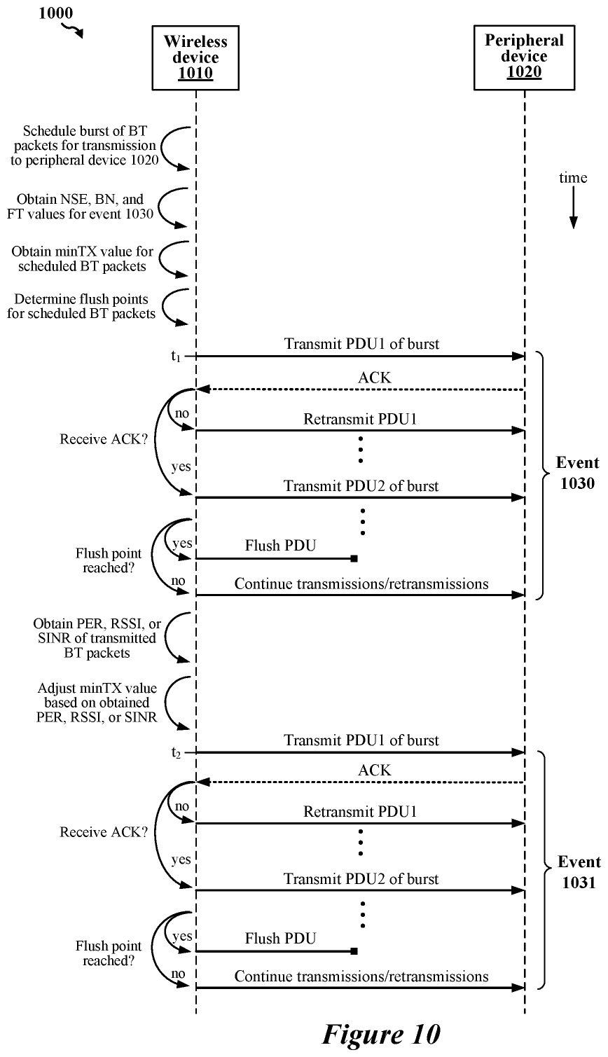

FIG. 10 shows a sequence diagram depicting an example wireless communication 1000 that supports configuring the flush points associated with the transmission of a burst of Bluetooth packets over a Bluetooth link, according to various aspects of the present disclosure. The example wireless communication 1000 may be performed between a wireless device 1010 and a peripheral device 1020. The wireless device 1010 may be an example of the central device 102 of FIG. 1, the wireless device 200 of FIG. 2, the wireless device 410 of FIG. 4, the wireless device 500 of FIG. 5, or the wireless device 701 described with reference to FIGS. 7A-7D, 8A-8D, and 9A-9B. The peripheral device 1020, which may be paired with the wireless device 1010 via the Bluetooth link, may be an example of one or more of the peripheral devices 104, 106, 108, 110, 112, or 114 described with reference to FIG. 1, the peripheral device 420 of FIG. 4-5, or the peripheral device 702 described with reference to FIGS. 7A-7D, 8A-8D, and 9A-9B. In some aspects, the Bluetooth link may be one of a Low Energy (LE) connected isochronous (ISO) link or an LE broadcast ISO link. In some other implementations, the wireless communication 1000 may be performed by the peripheral device 1020 in conjunction with the transmission of a burst of Bluetooth packets to the wireless device 1010 over the Bluetooth link, for example, as described with reference to FIG. 10.

Prior to time t₁, the wireless device 1010 schedules a burst of Bluetooth packets for transmission to the peripheral device 1020 over the Bluetooth link during one or more events 1030 and 1031. In some instances, the one or more events 1030 and 1031 may be CIS events. In other instances, the one or more events 1030 and 1031 may be BIG events. The wireless device 1010 obtains value of NSE, BN, and FT for the first event 1030, and then selects, determines, or otherwise obtains the minTx value for the first event 1030. In various implementations, the wireless device 1010 determines the flush points associated with Bluetooth packets queued for transmission during the first event 1030. In some instances, the flush points may be selected or determined independently of at least one of the NSE, BN, or FT.

In some aspects, the number of sub-events between flush points associated with Bluetooth packets queued in adjacent positions of a transmit buffer may be equal to the value of minTx. For example, when the minTx value is zero, the flush points associated with adjacent queued Bluetooth packets are separated from each other by zero sub-events. Thus, when the minTx value is zero, all of the Bluetooth packets queued for transmission during the first event 1030 have the same or common flush point. For another example, when the minTx value is one, the flush points associated with adjacent queued Bluetooth packets are separated from each other by one sub-event. As such, the flush points for Bluetooth packets scheduled for transmission during the first event 1030 may occupy of set of contiguous sub-events within the first event 1030 when minTx=1. For another example, when the minTx value is two, the flush points associated with adjacent queued Bluetooth packets are separated from each another by two sub-events. As such, the flush points for Bluetooth packets scheduled for transmission during the first event 1030 may occupy of set of alternating sub-events within the event 1030 when minTx=2.

At time t₁, the wireless device 1010 transmits the first packet PDU1 of the burst to the peripheral device 702 over the Bluetooth link during a first sub-event of the first event 1030. If the wireless device 1010 does not receive an ACK confirming reception of PDU1 by the peripheral device 1020, the wireless device 1010 retransmits PDU1 to the peripheral device 1020 during one or more subsequent sub-events of the first event 1030 until an ACK is received from the peripheral device 1030 or the flush point associated with PDU1 expires. Conversely, if the wireless device 1010 receives an ACK confirming reception of PDU1 by the peripheral device 1020, the wireless device 1010 increments the cisPayloadCounter parameter, and transmits the second packet PDU2 of the burst to the peripheral device 702 during a second sub-event of the first event 1030. The transmission and retransmission of PDUs of the burst continue in the manner described with reference to one or more of FIGS. 7A-7D, 8A-8D, or 9A-9B until either all of the Bluetooth packets of the burst are successfully delivered to the peripheral device 1020 or all of the sub-events of the first event 1030 are used.

After the first event 1030 ends, the wireless device 1010 may obtain an indication of one or more conditions associated with the transmission of Bluetooth packets to the peripheral device 1020. In some instances, the wireless device 1010 receives the indications on an LE ACL link associated with the LE ISO link between the wireless device 1010 and the peripheral device 1020. For example, in some instances, the wireless device 1010 may obtain a packet error rate (PER) associated with the transmission of Bluetooth packets to the peripheral device 1020 over the Bluetooth link, and may selectively adjust the minTx value based at least in part on the obtained PER. In some aspects, the wireless device 1010 may decrease the minTx value responsive to the obtained PER being greater than a first PER threshold, or may increase the minTx value responsive to the obtained PER being less than a second PER threshold, the first PER threshold being greater than the second PER threshold. In other instances, the wireless device 1010 may obtain an indication of a signal strength associated with the transmission of Bluetooth packets to the peripheral device 1020 over the Bluetooth link, and may selectively adjust the minTx value based at least in part on the obtained indication. In some aspects, the wireless device 1010 may increase the minTx value responsive to the indicated signal strength being greater than a first value, or may decrease the minTx value responsive to the indicated signal strength being less than a second value, the first value being greater than the second value. Thereafter, the wireless device 1010 may transmit another burst of Bluetooth packets to the peripheral device 1020 during the second event 1031 based on the adjusted minTx value.

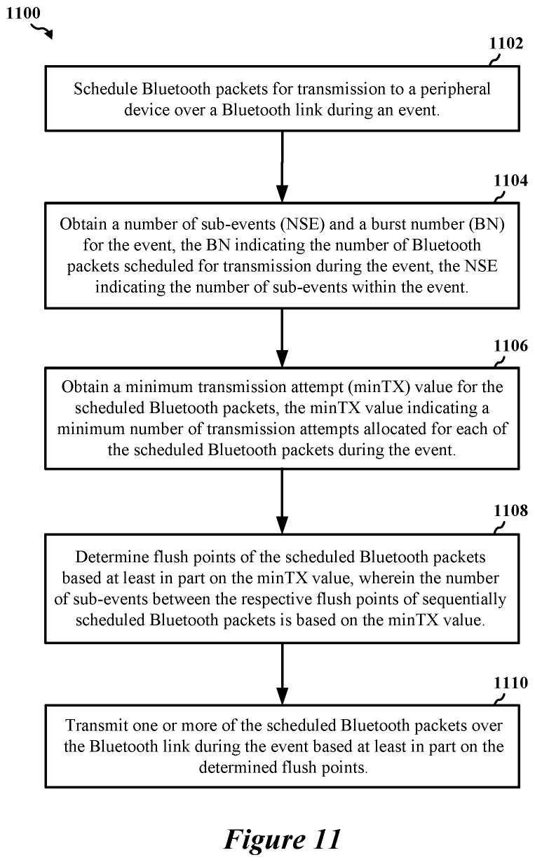

FIG. 11 shows a flowchart illustrating an example operation 1100 for wireless communication that supports configuring the flush points associated with a burst of Bluetooth data, according to various aspects of the present disclosure. The operation 1100 may be performed by a wireless device such as the central device 102 of FIG. 1, the wireless device 200 of FIG. 2, or the wireless device 500 of FIG. 5. In some implementations, the wireless device may be connected to or paired with a peripheral device over a Bluetooth link. The peripheral device may be any suitable wireless communication device including the peripheral devices 104, 106, 108, 110, 112, 114, or 116 of FIG. 1, the wireless device 200 of FIG. 2, or the peripheral device 420 of FIGS. 4-5. In some aspects, the wireless device may be an example of the wireless device 701 of FIGS. 7A-7D, 8A-8D, and 9A-9B, and the peripheral device may be an example of the peripheral device 702 of FIGS. 7A-7D, 8A-8D, and 9A-9B.

In some instances, the wireless device may operate as a STA associated with a WLAN while also operating as a softAP with which the peripheral device is associated. In various aspects, the wireless device may be a smartphone, and the peripheral device may be or may include headphones, headsets, or pairs of earbuds. In some instances, the audio data may be real-time streaming audio. In other instances, the audio data may be an audio stream associated with a real-time gaming application. In some other instances, the audio data may be latency-sensitive traffic.

For example, at 1102, the wireless device schedules Bluetooth packets for transmission to a peripheral device over a Bluetooth link during an event. At 1104, the wireless device obtains a number of sub-events (NSE) and a burst number (BN) for the event, the BN indicating the number of Bluetooth packets scheduled for transmission during the event, the NSE indicating the number of sub-events within the event. At 1106, the wireless device obtains a minimum transmission attempt (minTx) value for the scheduled Bluetooth packets, the minTx value indicating a minimum number of transmission attempts allocated for each of the scheduled Bluetooth packets during the event. At 1108, the wireless device determines flush points of the scheduled Bluetooth packets based at least in part on the minTx value, where the number of sub-events between the respective flush points of sequentially scheduled Bluetooth packets is based on the minTx value. At 1110, the wireless device transmits one or more of the scheduled Bluetooth packets over the Bluetooth link during the event based at least in part on the determined flush points. In various implementations, the minTx value is obtained independently of at least one of the NSE or the BN. In some aspects, the Bluetooth link may be one of an LE connected ISO link or an LE broadcast ISO link.

In some implementations, the minTx value may be equal to 0, and the scheduled Bluetooth packets may share a common flush point with one another. In some instances, the common flush point occurs in a last sub-event of the NSE sub-events. In other implementations, the minTx value may be equal to 1, and the respective flush points of the scheduled Bluetooth packets occur in a set of contiguous sub-events of the NSE sub-events. In some instances, the set of contiguous sub-events correspond to a last number of the NSE sub-events within the event. In some aspects, the last number of the NSE sub-events is equal to the BN. In some other implementations, the minTx value may be equal to 2, and the flush points of the scheduled Bluetooth packets occur in a set of alternating sub-events of the NSE sub-events within the event. In some aspects, the set of alternating sub-events corresponds to a last number of the NSE sub-events within the event, the last number being equal to 2*BN.

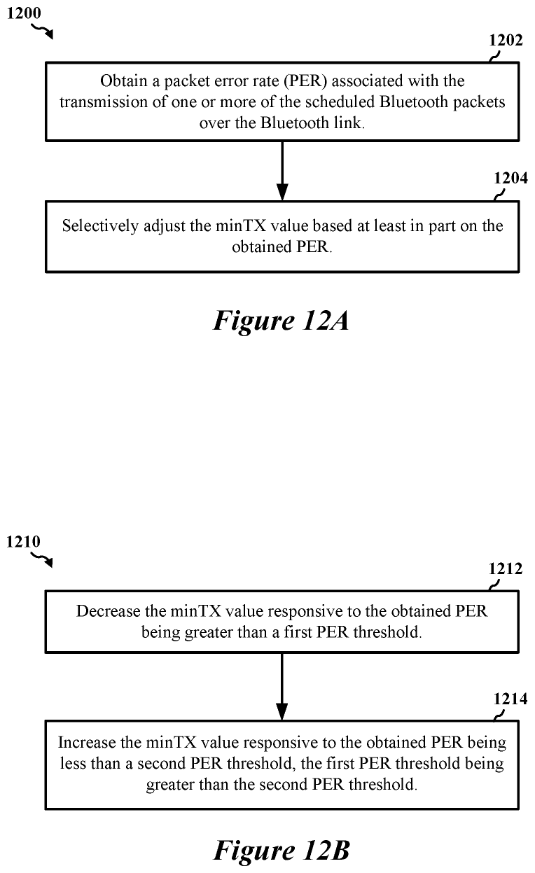

FIG. 12A shows a flowchart illustrating another example operation 1200 for wireless communication that supports adjusting the flush points associated with a burst of Bluetooth data, according to various aspects of the present disclosure. In some instances, the operation 1200 may be performed after the operation 1100 of FIG. 11. For example, at 1202, the wireless device obtains a packet error rate (PER) associated with the transmission of one or more of the scheduled Bluetooth packets over the Bluetooth link. At 1204, the wireless device selectively adjusts the minTx value based at least in part on the obtained PER.

FIG. 12B shows a flowchart illustrating another example operation 1210 for wireless communication that supports adjusting the flush points associated with a burst of Bluetooth data, according to various aspects of the present disclosure. In some instances, the operation 1210 may be one implementation of selectively adjusting the value of minTx at 1204 of FIG. 12A. For example, at 1212, the wireless device decreases the minTx value responsive to the obtained PER being greater than a first PER threshold. At 1214, the wireless device increases the minTx value responsive to the obtained PER being less than a second PER threshold, the first PER threshold being greater than the second PER threshold. In this way, the wireless device can move the respective flush points to later sub-events when the PER of the Bluetooth stream is relatively high, and can move the respective flush points to earlier sub-events when the PER of the Bluetooth stream is relatively low.

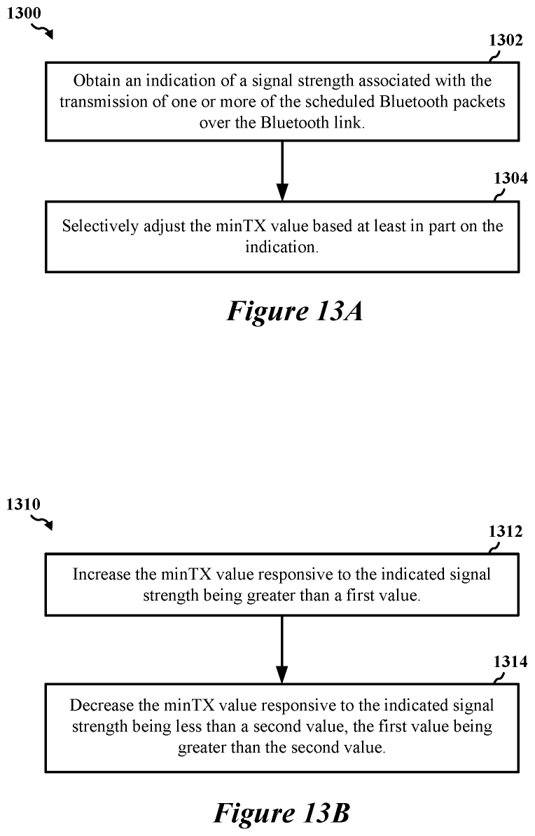

FIG. 13A shows a flowchart illustrating another example operation 1300 for wireless communication that supports adjusting configuring the flush points associated with a burst of Bluetooth data, according to various aspects of the present disclosure. In some instances, the operation 1300 may be performed after the operation 1100 of FIG. 11. For example, at 1302, the wireless device obtains an indication of a signal strength associated with the transmission of one or more of the scheduled Bluetooth packets over the Bluetooth link. At 1304, the wireless device selectively adjusts the minTx value based at least in part on the indication. In some aspects, the indication includes one or more of a received signal strength indicator (RSSI), a signal-to-noise ratio (SNR), a signal-to-interference plus noise ratio (SINR), or an energy level of a respective Bluetooth packet transmitted over the Bluetooth link.

FIG. 13B shows a flowchart illustrating another example operation 1310 for wireless communication that supports adjusting the flush points associated with a burst of Bluetooth data, according to various aspects of the present disclosure. In some instances, the operation 1310 may be one implementation of selectively adjusting the value of minTx at 1304 of FIG. 13A. For example, at 1312, the wireless device increases the minTx value responsive to the indicated signal strength being greater than a first value. At 1314, the wireless device decreases the minTx value responsive to the indicated signal strength being less than a second value, the first value being greater than the second value.

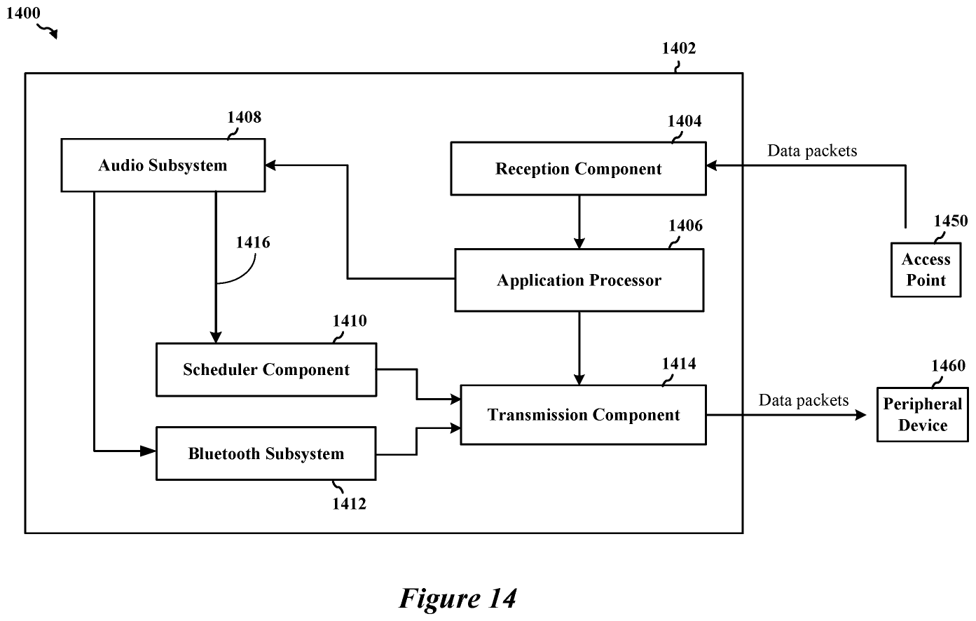

FIG. 14 is a conceptual data flow diagram 1400 illustrating the data flow between different means and/or components of an example apparatus 1402. In some implementations, the apparatus may be a wireless device that is paired with a peripheral device over a Bluetooth connection or link. The apparatus includes a reception component 1404 that receives data packets from other wireless communication devices including (but not limited to) an access point (AP) 1450 and a peripheral device 1460. The apparatus also includes an application processor 1406, an audio subsystem 1408, a scheduler component 1410, a Bluetooth subsystem 1412, and a transmission component 1414.

The application processor 1406 extracts data (such as audio data and/or video data) from received data packets, attaches or applies a Bluetooth profile to the extracted data, and routes the extracted data to the audio subsystem 1408. The audio subsystem 1408 encodes the extracted data, and routes the encoded data to the Bluetooth subsystem 1412. The Bluetooth subsystem 1412 embeds the encoded data into Bluetooth frames, encapsulates the Bluetooth frames within one or more Bluetooth packets, and forwards the Bluetooth packets to the transmission component 1414 for transmission to a peripheral device 1460 over the Bluetooth link. The transmission component 1414 is coupled to the Bluetooth subsystem 1412, and may be used to transmit frames or packets provided by the Bluetooth subsystem 1412 to the peripheral device 1460 (and/or other communication devices).

The scheduler component 1410 may be used to schedule Bluetooth packets for transmission to the peripheral device 1460 over a Bluetooth link during an event. For example, in some instances, the scheduler component 1410 may schedule the burst of Bluetooth packets for transmission to the peripheral device 1460 based at least in part on the NSE, BN, and FT values associated with the connection event. The scheduler component 1410 may also select or determine the minTx value for the connection event, independently of the NSE and BN values, and then determine the flush points for the burst of Bluetooth packets. The scheduler component 1410 may forward the Bluetooth packets, along with the determined flush points, to the transmission component 1414 for transmission over the Bluetooth link to the peripheral device 1460.

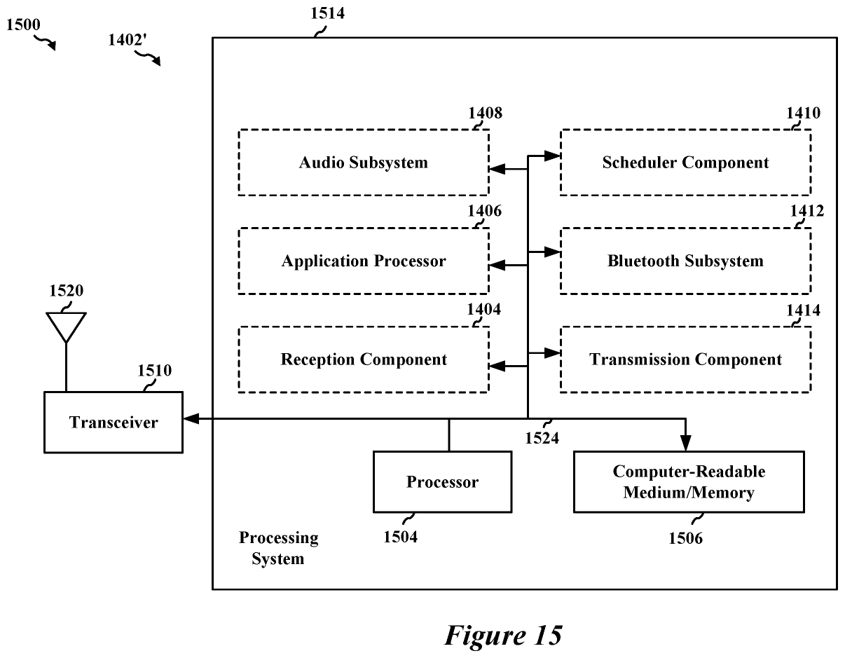

FIG. 15 is a diagram 1500 illustrating an example of a hardware implementation for an apparatus 1402′ employing a processing system 1514. The processing system 1514 may be implemented with a bus architecture, represented generally by the bus 1524. The bus 1524 may include any number of interconnecting buses and bridges depending on the specific application of the processing system 1514 and the overall design constraints. The bus 1524 links together various circuits including one or more processors and/or hardware components, represented by the processor 1504, the components 1404, 1406, 1408, 1410, 1412, and 1414 and the computer-readable medium/memory 1506. The bus 1524 may also link various other circuits such as timing sources, peripherals, voltage regulators, and power management circuits, which are well known in the art, and therefore, will not be described any further.

The processing system 1514 may be coupled to a transceiver 1510. The transceiver 1510 is coupled to one or more antennas 1520. The transceiver 1510 provides a means for communicating with various other apparatus over a transmission medium. The transceiver 1510 receives a signal from the one or more antennas 1520, extracts information from the received signal, and provides the extracted information to the processing system 1514, specifically the reception component 1404. In addition, the transceiver 1510 receives information from the processing system 1514, specifically the transmission component 1414, and based on the received information, generates a signal to be applied to the one or more antennas 1520. The processing system 1514 includes a processor 1504 coupled to a computer-readable medium/memory 1506. The processor 1504 is responsible for general processing, including the execution of software stored on the computer-readable medium/memory 1506. The software, when executed by the processor 1504, causes the processing system 1514 to perform the various functions described supra for any particular apparatus. The computer-readable medium/memory 1506 may also be used for storing data that is manipulated by the processor 1504 when executing software. The processing system 1514 further includes at least one of the components 1404, 1406, 1408, 1410, 1412, and 1414. The components may be software components running in the processor 1504, resident/stored in the computer readable medium/memory 1506, one or more hardware components coupled to the processor 1504, or some combination thereof.

In certain configurations, the apparatus 1402/1402′ for wireless communication may include means for all means limitations described herein. The aforementioned means may be the processor(s) 202, the radio 230, the MMU 240, the WLAN controller 250, the Bluetooth controller 252, the WWAN controller 256, one or more of the aforementioned components of the apparatus 1402 and/or the processing system 1514 of the apparatus 1402′ configured to perform the functions recited by the aforementioned means.

In one configuration, the apparatus 1402/1402′ for wireless communication includes means for scheduling Bluetooth packets for transmission to a peripheral device over a Bluetooth link during an event, and means for obtaining a number of sub-events (NSE) and a burst number (BN) for the event, the BN indicating the number of Bluetooth packets scheduled for transmission during the event, the NSE indicating the number of sub-events within the event. The apparatus 1402/1402′ for wireless communication may also include means for obtaining a minimum transmission attempt (minTx) value for the scheduled Bluetooth packets, the minTx value indicating a minimum number of transmission attempts allocated for each of the scheduled Bluetooth packets during the event. The apparatus 1402/1402′ for wireless communication may also include means for determining flush points of the scheduled Bluetooth packets based at least in part on the minTx value, where the number of sub-events between the respective flush points of sequentially scheduled Bluetooth packets is based on the minTx value. The apparatus 1402/1402′ for wireless communication may also include means for transmitting one or more of the scheduled Bluetooth packets over the Bluetooth link during the event based at least in part on the determined flush points.

The aforementioned means may be one or more of the aforementioned components of the apparatus 1402 and/or the processing system 1514 of the apparatus 1402′ configured to perform the functions recited by the aforementioned means. As described supra, the processing system 1514 may include the processors 202, the memory 206, the flash memory 210, and/or the ROM 208 of FIG. 2.

The apparatus 1402/1402′ for wireless communication may include additional components that perform each of the blocks of the algorithm in the flowcharts of FIGS. 11, 12A-12B, and 13A-13B. As such, each block in the flowcharts of FIGS. 11, 12A-12B, and 13A-13B may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

Implementation examples are described in the following numbered clauses:
1. A method of wireless communication by a wireless device, the method including:
scheduling Bluetooth packets for transmission to a peripheral device over a Bluetooth link during an event;
obtaining a number of sub-events (NSE) and a burst number (BN) for the event, the BN indicating the number of Bluetooth packets scheduled for transmission during the event, the NSE indicating the number of sub-events within the event;
obtaining a minimum transmission attempt (minTx) value for the scheduled Bluetooth packets, the minTx value indicating a minimum number of transmission attempts allocated for each of the scheduled Bluetooth packets during the event;
determining flush points of the scheduled Bluetooth packets based at least in part on the minTx value, where the number of sub-events between the respective flush points of sequentially scheduled Bluetooth packets is based on the minTx value; and
transmitting one or more of the scheduled Bluetooth packets over the Bluetooth link during the event based at least in part on the determined flush points.
2. The method of clause 1, where the minTx value is obtained independently of at least one of the NSE or the BN.
3 The method of clause 1, where the Bluetooth link is one of a Low Energy (LE) connected isochronous (ISO) link or an LE broadcast ISO link.
4. The method of any one or more of clauses 1-3, where the minTx value is equal to 0, and the scheduled Bluetooth packets share a common flush point.
5. The method of clause 4, where the common flush point occurs in a last sub-event of the NSE sub-events within the event.
6 The method of any one or more of clauses 1-5, where the minTx value is equal to 1, and the respective flush points of the scheduled Bluetooth packets occur in a set of contiguous sub-events of the NSE sub-events within the event.
7. The method of clause 6, where the contiguous sub-events correspond to a last number of the NSE sub-events within the event.
8. The method of clause 7, where the last number of the NSE sub-events is equal to the BN.
9. The method of clause 1, where the minTx value is equal to 2, and the flush points of the scheduled Bluetooth packets occur in alternating sub-events of the NSE sub-events within the event.
10. The method of clause 9, where the alternating sub-events correspond to a last number of the NSE sub-events within the event, the last number being equal to 2*BN.
11. The method of any one or more of clauses 1-10, further including:
obtaining a packet error rate (PER) associated with the transmission of one or more of the scheduled Bluetooth packets over the Bluetooth link; and
selectively adjusting the minTx value based at least in part on the obtained PER.
12. The method of clause 11, where selectively adjusting the minTx value includes:
decreasing the minTx value responsive to the obtained PER being greater than a first PER threshold; or
increasing the minTx value responsive to the obtained PER being less than a second PER threshold, the first PER threshold being greater than the second PER threshold.
13. The method of any one or more of clauses 1-12, further including:
obtaining an indication of a signal strength associated with the transmission of one or more of the scheduled Bluetooth packets over the Bluetooth link; and
selectively adjusting the minTx value based at least in part on the indication.
14. The method of clause 13, where the indication includes one or more of a received signal strength indicator (RSSI), a signal-to-noise ratio (SNR), a signal-to-interference plus noise ratio (SINR), or an energy level of a respective Bluetooth packet transmitted over the Bluetooth link.
15. The method of any one or more of clauses 13-14, where selectively adjusting the minTx value includes:
increasing the minTx value responsive to the indicated signal strength being greater than a first value; or
decreasing the minTx value responsive to the indicated signal strength being less than a second value, the first value being greater than the second value.
16. A wireless device, including:
one or more processors; and
a memory coupled to the one or more processors and storing processor-readable code that, when executed by the one or more processors, is configured to:
   schedule Bluetooth packets for transmission to a peripheral device over a Bluetooth link during an event;
   obtain a number of sub-events (NSE) and a burst number (BN) for the event, the BN indicating the number of Bluetooth packets scheduled for transmission during the event, the NSE indicating the number of sub-events within the event;
   obtain a minimum transmission attempt (minTx) value for the scheduled Bluetooth packets, the minTx value indicating a minimum number of transmission attempts allocated for each of the scheduled Bluetooth packets during the event;
   determine flush points of the scheduled Bluetooth packets based at least in part on the minTx value, where the number of sub-events between the respective flush points of sequentially scheduled Bluetooth packets is based on the minTx value; and
   transmit one or more of the scheduled Bluetooth packets over the Bluetooth link during the event based at least in part on the determined flush points.
17. The wireless device of clause 16, where the minTx value is obtained independently of at least one of the NSE or the BN.
18. The wireless device of clause 16, where the minTx value is equal to 0, and the scheduled Bluetooth packets share a common flush point.
19. The wireless device of clause 18, where the common flush point occurs in a last sub-event of the NSE sub-events within the event.
20. The wireless device of any one or more of clauses 16-19, where the minTx value is equal to 1, and the flush points of the scheduled Bluetooth packets occur in a set of contiguous sub-events of the NSE sub-events within the event.
21. The wireless device of clause 20, where the contiguous sub-events correspond to a last number of the NSE sub-events within the event.
22. The wireless device of clause 21, where the last number of the NSE sub-events is equal to the BN.
23. The wireless device of clause 16, where the minTx value is equal to 2, and the flush points of the scheduled Bluetooth packets occur in alternating sub-events of the NSE sub-events within the event.
24. The wireless device of clause 23, where the alternating sub-events correspond to a last number of the NSE sub-events within the event, the last number being equal to 2* BN.
25. The wireless device of any one or more of clauses 16-24, where execution of the processor-readable code is further configured to:
obtain a packet error rate (PER) associated with the transmission of one or more of the scheduled Bluetooth packets over the Bluetooth link; and selectively adjust the minTx value based at least in part on the obtained PER.
26. The wireless device of clause 25, where execution of the processor-readable code to selectively adjust the minTx value is further configured to:
decrease the minTx value responsive to the obtained PER being greater than a first PER threshold; or
increase the minTx value responsive to the obtained PER being less than a second PER threshold, the first PER threshold being greater than the second PER threshold.
27. The wireless device of any one or more of clauses 16-26, where execution of the processor-readable code is further configured to:
obtain an indication of a signal strength associated with the transmission of one or more of the scheduled Bluetooth packets over the Bluetooth link; and
selectively adjust the minTx value based at least in part on the indication.
28. The wireless device of clause 27, where execution of the processor-readable code to selectively adjust the minTx value is further configured to:
increase the minTx value responsive to the indicated signal strength being greater than a first value; or
decrease the minTx value responsive to the indicated signal strength being less than a second value, the first value being greater than the second value.
29. A wireless device, including:
means for scheduling Bluetooth packets for transmission to a peripheral device over a Bluetooth link during an event;
means for obtaining a number of sub-events (NSE) and a burst number (BN) for the event, the BN indicating the number of Bluetooth packets scheduled for transmission during the event, the NSE indicating the number of sub-events within the event;
means for obtaining a minimum transmission attempt (minTx) value for the scheduled Bluetooth packets, the minTx value indicating a minimum number of transmission attempts allocated for each of the scheduled Bluetooth packets during the event;
means for determining flush points of the scheduled Bluetooth packets based at least in part on the minTx value, where the number of sub-events between the respective flush points of sequentially scheduled Bluetooth packets is based on the minTx value; and
means for transmitting one or more of the scheduled Bluetooth packets over the Bluetooth link during the event based at least in part on the determined flush points.
30. A non-transitory computer-readable storage medium storing instructions, that, when executed by one or more processors of a wireless device, cause the wireless device to perform operations including:
scheduling Bluetooth packets for transmission to a peripheral device over a Bluetooth link during an event;
obtaining a number of sub-events (NSE) and a burst number (BN) for the event, the BN indicating the number of Bluetooth packets scheduled for transmission during the event, the NSE indicating the number of sub-events within the event;
obtaining a minimum transmission attempt (minTx) value for the scheduled Bluetooth packets, the minTx value indicating a minimum number of transmission attempts allocated for each of the scheduled Bluetooth packets during the event;
determining flush points of the scheduled Bluetooth packets based at least in part on the minTx value, where the number of sub-events between the respective flush points of sequentially scheduled Bluetooth packets is based on the minTx value; and
transmitting one or more of the scheduled Bluetooth packets over the Bluetooth link during the event based at least in part on the determined flush points.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations, and algorithm processes described in connection with the implementations disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described herein. Whether such functionality is implemented in hardware, firmware or software depends upon the particular application and design constraints imposed on the overall system.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described herein as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described herein should not be understood as requiring such separation in all implementations, and it should be understood that the described program components and systems can generally be integrated together in a single software product or packaged into multiple software products.

What is claimed is:

1. A method of wireless communication by a wireless device, the method comprising:
scheduling Bluetooth packets for transmission to a peripheral device over a Bluetooth link during an event;
obtaining a number of sub-events (NSE) and a burst number (BN) for the event, the BN indicating the number of Bluetooth packets scheduled for transmission during the event, the NSE indicating the number of sub-events within the event;
obtaining a minimum transmission attempt (minTx) value for the scheduled Bluetooth packets, the minTx value indicating a minimum number of transmission attempts allocated for each of the scheduled Bluetooth packets during the event;
determining flush points of the scheduled Bluetooth packets based at least in part on the minTx value, wherein the number of sub-events between the respective flush points of sequentially scheduled Bluetooth packets is based on the minTx value; and
transmitting one or more of the scheduled Bluetooth packets over the Bluetooth link during the event based at least in part on the determined flush points.

2. The method of claim 1, wherein the minTx value is obtained independently of at least one of the NSE or the BN.

3. The method of claim 1, wherein the Bluetooth link is one of a Low Energy (LE) connected isochronous (ISO) link or an LE broadcast ISO link.

4. The method of claim 1, wherein the minTx value is equal to 0, and the scheduled Bluetooth packets share a common flush point.

5. The method of claim 4, wherein the common flush point occurs in a last sub-event of the NSE sub-events within the event.

6. The method of claim 1, wherein the minTx value is equal to 1, and the respective flush points of the scheduled Bluetooth packets occur in a set of contiguous sub-events of the NSE sub-events within the event.

7. The method of claim 6, wherein the contiguous sub-events correspond to a last number of the NSE sub-events within the event.

8. The method of claim 7, wherein the last number of the NSE sub-events is equal to the BN.

9. The method of claim 1, wherein the minTx value is equal to 2, and the flush points of the scheduled Bluetooth packets occur in alternating sub-events of the NSE sub-events within the event.

10. The method of claim 9, wherein the alternating sub-events correspond to a last number of the NSE sub-events within the event, the last number being equal to 2*BN.

11. The method of claim 1, further comprising:
obtaining a packet error rate (PER) associated with the transmission of one or more of the scheduled Bluetooth packets over the Bluetooth link; and
selectively adjusting the minTx value based at least in part on the obtained PER.

12. The method of claim 11, wherein selectively adjusting the minTx value includes:
decreasing the minTx value responsive to the obtained PER being greater than a first PER threshold; or
increasing the minTx value responsive to the obtained PER being less than a second PER threshold, the first PER threshold being greater than the second PER threshold.

13. The method of claim 1, further comprising:
obtaining an indication of a signal strength associated with the transmission of one or more of the scheduled Bluetooth packets over the Bluetooth link; and
selectively adjusting the minTx value based at least in part on the indication.

14. The method of claim 13, wherein the indication includes one or more of a received signal strength indicator (RSSI), a signal-to-noise ratio (SNR), a signal-to-interference plus noise ratio (SINR), or an energy level of a respective Bluetooth packet transmitted over the Bluetooth link.

15. The method of claim 13, wherein selectively adjusting the minTx value includes:
increasing the minTx value responsive to the indicated signal strength being greater than a first value; or
decreasing the minTx value responsive to the indicated signal strength being less than a second value, the first value being greater than the second value.

16. A wireless device, comprising:
one or more processors; and
a memory coupled to the one or more processors and storing processor-readable code that, when executed by the one or more processors, is configured to:
schedule Bluetooth packets for transmission to a peripheral device over a Bluetooth link during an event;
obtain a number of sub-events (NSE) and a burst number (BN) for the event, the BN indicating the number of Bluetooth packets scheduled for transmission during the event, the NSE indicating the number of sub-events within the event;
obtain a minimum transmission attempt (minTx) value for the scheduled Bluetooth packets, the minTx value indicating a minimum number of transmission attempts allocated for each of the scheduled Bluetooth packets during the event;
determine flush points of the scheduled Bluetooth packets based at least in part on the minTx value, wherein the number of sub-events between the respective flush points of sequentially scheduled Bluetooth packets is based on the minTx value; and
transmit one or more of the scheduled Bluetooth packets over the Bluetooth link during the event based at least in part on the determined flush points.

17. The wireless device of claim 16, wherein the minTx value is obtained independently of at least one of the NSE or the BN.

18. The wireless device of claim 16, wherein the minTx value is equal to 0, and the scheduled Bluetooth packets share a common flush point.

19. The wireless device of claim 18, wherein the common flush point occurs in a last sub-event of the NSE sub-events within the event.

20. The wireless device of claim 16, wherein the minTx value is equal to 1, and the flush points of the scheduled Bluetooth packets occur in a set of contiguous sub-events of the NSE sub-events within the event.

21. The wireless device of claim 20, wherein the contiguous sub-events correspond to a last number of the NSE sub-events within the event.

22. The wireless device of claim 21, wherein the last number of the NSE sub-events is equal to the BN.

23. The wireless device of claim 16, wherein the minTx value is equal to 2, and the flush points of the scheduled Bluetooth packets occur in alternating sub-events of the NSE sub-events within the event.

24. The wireless device of claim 23, wherein the alternating sub-events correspond to a last number of the NSE sub-events within the event, the last number being equal to 2*BN.

25. The wireless device of claim 16, wherein execution of the processor-readable code is further configured to:
obtain a packet error rate (PER) associated with the transmission of one or more of the scheduled Bluetooth packets over the Bluetooth link; and
selectively adjust the minTx value based at least in part on the obtained PER.

26. The wireless device of claim 25, wherein execution of the processor-readable code to selectively adjust the minTx value is further configured to:
decrease the minTx value responsive to the obtained PER being greater than a first PER threshold; or
increase the minTx value responsive to the obtained PER being less than a second PER threshold, the first PER threshold being greater than the second PER threshold.

27. The wireless device of claim 16, wherein execution of the processor-readable code is further configured to:
obtain an indication of a signal strength associated with the transmission of one or more of the scheduled Bluetooth packets over the Bluetooth link; and
selectively adjust the minTx value based at least in part on the indication.

28. The wireless device of claim 27, wherein execution of the processor-readable code to selectively adjust the minTx value is further configured to:
increase the minTx value responsive to the indicated signal strength being greater than a first value; or
decrease the minTx value responsive to the indicated signal strength being less than a second value, the first value being greater than the second value.

29. A wireless device, comprising:
means for scheduling Bluetooth packets for transmission to a peripheral device over a Bluetooth link during an event;
means for obtaining a number of sub-events (NSE) and a burst number (BN) for the event, the BN indicating the number of Bluetooth packets scheduled for transmission during the event, the NSE indicating the number of sub-events within the event;
means for obtaining a minimum transmission attempt (minTx) value for the scheduled Bluetooth packets, the minTx value indicating a minimum number of transmission attempts allocated for each of the scheduled Bluetooth packets during the event;
means for determining flush points of the scheduled Bluetooth packets based at least in part on the minTx value, wherein the number of sub-events between the respective flush points of sequentially scheduled Bluetooth packets is based on the minTx value; and
means for transmitting one or more of the scheduled Bluetooth packets over the Bluetooth link during the event based at least in part on the determined flush points.

30. A non-transitory computer-readable storage medium storing instructions, that, when executed by one or more processors of a wireless device, cause the wireless device to perform operations including:
scheduling Bluetooth packets for transmission to a peripheral device over a Bluetooth link during an event;
obtaining a number of sub-events (NSE) and a burst number (BN) for the event, the BN indicating the number of Bluetooth packets scheduled for transmission during the event, the NSE indicating the number of sub-events within the event;
obtaining a minimum transmission attempt (minTx) value for the scheduled Bluetooth packets, the minTx value indicating a minimum number of transmission attempts allocated for each of the scheduled Bluetooth packets during the event;
determining flush points of the scheduled Bluetooth packets based at least in part on the minTx value, wherein the number of sub-events between the respective flush points of sequentially scheduled Bluetooth packets is based on the minTx value; and
transmitting one or more of the scheduled Bluetooth packets over the Bluetooth link during the event based at least in part on the determined flush points.
